(19) United States
(12) Patent Application Publication
(10) Pub. No.: US 2020/0381711 A1
(43) Pub. Date: Dec. 3, 2020

(54) SILICON-DOMINANT BATTERY ELECTRODES

(71) Applicant: Enevate Corporation, Irvine, CA (US)

(72) Inventors: Rahul R. Kamath, Mission Viejo, CA (US); Giulia Canton, Irvine, CA (US); Ian Russell Browne, Orange, CA (US)

(21) Appl. No.: 16/430,286

(22) Filed: Jun. 3, 2019

(51) Int. Cl. H01M 4/36; H01M 4/38; H01M 4/583; H01M 4/04; B29C 41/00; B28B 11/24

(52) U.S. Cl. CPC H01M 4/364; H01M 4/386; H01M 4/583; B29K 2507/00; B29C 41/003; B28B 11/243; H01M 4/0471

(57) ABSTRACT

Methods of forming a composite material film can include providing a mixture comprising a carbon precursor and silicon particles. The methods can also include pyrolysing the carbon precursor to convert the precursor into one or more types of carbon phases to form the composite material film such that the precursor has a char yield of greater than about 0% to about 60% and the composite material film comprises the silicon particles at about 90% to about 99% by weight.

### BACKGROUND

### Field

The present application relates generally to silicon-dominant battery electrodes. In particular, the present application relates to composite materials including greater than 50% by weight of silicon particles, and in some instances 90% or greater by weight of silicon particles, for use in battery electrodes.

### Description of the Related Art

A lithium ion battery typically includes a separator and/or electrolyte between an anode and a cathode. In one class of batteries, the separator, cathode and anode materials are individually formed into sheets or films. Sheets of the cathode, separator and anode are subsequently stacked or rolled with the separator separating the cathode and anode (e.g., electrodes) to form the battery. Typical electrodes include electro-chemically active material layers on electrically conductive metals (e.g., aluminum and copper). Films can be rolled or cut into pieces which are then layered into stacks. The stacks are of alternating electro-chemically active materials with the separator between them.

### SUMMARY

In certain implementations, a method of forming a composite material film is provided. The method can include providing a mixture comprising a carbon precursor and silicon particles. The method can also include pyrolysing the carbon precursor to convert the precursor into one or more types of carbon phases to form the composite material film such that the precursor has a char yield of greater than about 0% to about 60% and the composite material film comprises the silicon particles at about 90% to about 99% by weight. For example, the composite material film can comprise the silicon particles at about 95% to about 99% by weight.

In some instances, the carbon precursor can comprise polyacrylonitrile (PAN). In some instances, the carbon precursor can comprise cellulose, glucose, sucrose, lignin, dextran, or a combination thereof. In some instances, the carbon precursor can comprise polyimide, phenol formaldehyde resin, or a combination thereof. In some instances, the carbon precursor can comprise polyamic acid. For example, the carbon precursor can comprise dianhydride and/or diamine. In some such examples, the carbon precursor can comprise pyromellitic dianhydride oxidianiline (PMDA-ODA), biphenyl tetracarboxylic acid dianhydride-p-phenylene diamine (BPDA-PDA), pyromellitic dianhydride-p-phenylene diamine (PMDA-PDA), or a combination thereof.

In some instances, the mixture can further comprise a solvent comprising N-Methylpyrrolidone (NMP). In some instances, the mixture can further comprise an aprotic solvent. For example, the aprotic solvent can comprise of any one or mixture of dimethylformamide (DMF), dimethoxymethamphetamine (DMMA), dimethylacetamide (DMAc), dimethyl sulfoxide (DMSO), sulfolane, ethylene carbonate, or a combination thereof.

In some instances, the mixture can further comprise an inorganic salt. For example, the inorganic salt can comprise lithium bromide, sodium thiocyanate, zinc chloride, or a combination thereof. In some instances, the mixture can further comprise sulfuric acid, nitric acid, or a combination thereof.

In some implementations, the method can further comprise coating the mixture on a substrate to form a green film. The method can further comprise removing the green film from the substrate prior to pyrolysing the carbon precursor. In some examples, the substrate can comprise polyethylene terephthalate (PET), cyclic olefin copolymer (COC), or a combination thereof. In some examples, pyrolysing can comprise pyrolysing the green film on the substrate. The substrate can comprise a polymer having about 0% to about 5% char yield. For example, the substrate can comprise acetal, polypropylene, polyethylene, polystyrene, or a combination thereof.

In some implementations, the method can further comprise oxidizing the mixture prior to pyrolysing. In some examples, pyrolysing can comprise heating the mixture at a temperature in a range of about 350° C. to about 1350° C. In some instances, pyrolysing can form the composite material film as a self-supported structure.

In certain implementations, a composite material film is provided. The film can include about 90% to about 99% by weight silicon particles. The film can also include greater than 0% and less than or equal to about 10% by weight of one or more types of carbon phases. At least one of the one or more types of carbon phases can comprise hard carbon as a matrix phase that holds the composite material film together such that the silicon particles are distributed throughout the composite material film. In some examples, the composite material film can comprise the silicon particles at about 95% to about 99% by weight of the composite material film.

In some implementations, the silicon particles can have an average particle size from about 10 nm to about 40 μm. In some instances, the hard carbon can comprise glassy carbon. Some films can further comprise a silicon carbide layer between the silicon particles and the hard carbon. In some examples, the matrix phase can be a substantially continuous phase. In some instances, the silicon particles can be homogenously distributed throughout the hard carbon. The composite material film can be self-supported.

In some implementations, at least one of the one or more types of carbon phases can be electrochemically active and electrically conductive. One or more types of carbon phases can further comprise graphite particles. The composite material film can be substantially electrochemically active.

In certain implementations, a battery electrode is provided. The electrode can be an anode. The composite material film can be self-supported. In some examples, the electrode can further comprise a current collector. The electrode can further comprise a polymer adhesive between the composite material film and the current collector.

In some implementations, a battery is provided. The battery can comprise an anode comprising the composite material film, a cathode, and electrolyte. The battery can be a lithium ion battery. In some examples, the cathode can comprise nickel cobalt manganese (NCM), lithium cobalt oxide (LCO), nickel cobalt aluminum oxide (NCAO), lithium manganese oxide (LMO), lithium manganese oxide (LMO), lithium nickel manganese oxide (LNMO), or lithium iron phosphate (LFP). In some instances, the electrolyte can be in a liquid state. In some instances, the electrolyte can be in a solid state.

### BRIEF DESCRIPTION OF THE DRAWINGS

FIG. 1A illustrates an embodiment of a method of forming a composite material that includes forming a mixture that includes a precursor, casting the mixture, drying the mixture, curing the mixture, and pyrolyzing the precursor;

FIG. 1B is a schematic illustration of the formation of silicon carbide on a silicon particle;

FIGS. 2A and 2B are SEM micrographs of one embodiment of micron-sized silicon particles milled-down from larger silicon particles;

FIGS. 2C and 2D are SEM micrographs of one embodiment of micron-sized silicon particles with nanometer-sized features on the surface;

FIG. 3 illustrates an example embodiment of a method of forming a composite material;

FIG. 4 is a plot of the discharge capacity at an average rate of C/2.6;

FIG. 5 is a plot of the discharge capacity at an average rate of C/3;

FIG. 6 is a plot of the discharge capacity at an average rate of C/3.3;

FIG. 7 is a plot of the discharge capacity at an average rate of C/5;

FIG. 8 is a plot of the discharge capacity at an average rate of C/9;

FIG. 9 is a plot of the discharge capacity;

FIG. 10 is a plot of the discharge capacity at an average rate of C/9;

FIGS. 11A and 11B are plots of the reversible and irreversible capacity as a function of the various weight percentage of PI derived carbon from 2611c and graphite particles for a fixed percentage of 20 wt. % Si;

FIG. 12 is a plot of the first cycle discharge capacity as a function of weight percentage of carbon;

FIG. 13 is a plot of the reversible (discharge) and irreversible capacity as a function of pyrolysis temperature;

FIG. 14 is a photograph of a 4.3 cm×4.3 cm composite anode film without a metal foil support layer;

FIG. 15 is a scanning electron microscope (SEM) micrograph of a composite anode film before being cycled (the out-of-focus portion is a bottom portion of the anode and the portion that is in focus is a cleaved edge of the composite film);

FIG. 16 is another SEM micrograph of a composite anode film before being cycled;

FIG. 17 is a SEM micrograph of a composite anode film after being cycled 10 cycles;

FIG. 18 is another SEM micrograph of a composite anode film after being cycled 10 cycles;

FIG. 19 is a SEM micrograph of a composite anode film after being cycled 300 cycles;

FIG. 20 includes SEM micrographs of cross-sections of composite anode films;

FIG. 21 is an x-ray powder diffraction (XRD) graph of the sample silicon particles;

FIG. 22 is a SEM micrograph of one embodiment of silicon particles;

FIG. 23 is another SEM micrographs of one embodiment of silicon particles;

FIG. 24 is a SEM micrograph of one embodiment of silicon particles;

FIG. 25 is a SEM micrograph of one embodiment of silicon particles;

FIG. 26 is a chemical analysis of the sample silicon particles;

FIGS. 27A and 27B are example particle size histograms of two micron-sized silicon particles with nanometer-sized features;

FIG. 28 is a plot of discharge capacity during cell cycling comparing two types of example silicon particles;

FIG. 29 shows stabilization and char yields of polyacrylonitrile under different heat treatment conditions;

FIG. 30 shows a graph of capacity versus cycle number for cells with example silicon-dominant anodes;

FIG. 31 shows a graph of capacity retention versus cycle number for cells with example silicon-dominant anodes; and

FIG. 32 shows a graph of cell resistance versus cycle number for cells with example silicon-dominant anodes.

### DETAILED DESCRIPTION

Certain embodiments comprise silicon electrodes (e.g., anodes and/or cathodes) that include silicon or a composite material containing silicon for battery applications (e.g., lithium ion battery applications). Silicon is recognized as a potentially high energy per unit volume host material for lithium ion lithium battery applications. Batteries with silicon anodes can exhibit more rapid capacity loss upon cycling compared with batteries with graphite anodes. The repeated expansion and contraction of silicon particles during charge and discharge can lead to mechanical failure of the anode during cycling.

Silicon particles (nano and micron sized) can be dispersed in slurries which includes carbon precursor polymers as binders and some solvents. These slurries are coated on appropriate substrates, dried, and peeled off of the substrate. Heat treatment of the substrateless green electrodes in inert or reducing atmospheres can produce electrode films that have up to 90% silicon by weight. Such process may produce electrodes containing up to 90% silicon particles by weight held together by a carbon network providing conducting pathways. In some instances, these electrodes can be attached to a polymer adhesive coated current collector with or without heat treatment.

In accordance with certain embodiments described herein, silicon dominant electrodes with 90% or greater of silicon particles by weight can be produced, e.g., using low char yield polymers, such as polyacrylonitrile (PAN) as a binder/carbon precursor. Low char yield polymers can yield a low amount of carbon, allowing a high amount of silicon in the composite material. These heat treated silicon composites have shown low cell resistance and high capacity retention when cycled over 150 cycles.

Furthermore, in some embodiments, the oxidation process parameters such as temperature, time, and air/oxygen flow can be adjusted to control the level of oxidation. Depending on the oxidation and the pyrolysis process, the char yield of the polymer precursor and thus the final Si weight % in the silicon-carbon composite electrode can be controlled.

Typical carbon anode electrodes include a current collector such as a copper sheet. Carbon is deposited onto the collector along with an inactive binder material. Carbon is often used because it has excellent electrochemical properties and is also electrically conductive. If the current collector layer (e.g., copper layer) was removed, the carbon would likely be unable to mechanically support itself. Therefore, conventional electrodes require a support structure such as the collector to be able to function as an electrode. The electrode (e.g., anode or cathode) compositions described in this application can produce electrodes that are self-supported. The need for a metal foil current collector is eliminated or minimized because conductive carbonized polymer is used for current collection in the anode structure as well as for mechanical support. In typical applications for the mobile industry, a metal current collector is typically added to ensure sufficient rate performance. The carbonized polymer can form a substantially continuous conductive carbon phase in the entire electrode as opposed to particulate carbon suspended in a non-conductive binder in one class of conventional lithium-ion battery electrodes. Advantages of a carbon composite blend that utilizes a carbonized polymer can include, for example, 1) higher capacity, 2) enhanced overcharge/discharge protection, 3) lower irreversible capacity due to the elimination (or minimization) of metal foil current collectors, and 4) potential cost savings due to simpler manufacturing.

Anode electrodes currently used in the rechargeable lithium-ion cells typically have a specific capacity of approximately 200 milliamp hours per gram (including the metal foil current collector, conductive additives, and binder material). Graphite, the active material used in most lithium ion battery anodes, has a theoretical energy density of 372 milliampere hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Several types of silicon materials, e.g., silicon nanopowders, silicon nanowires, porous silicon, and ball-milled silicon, have also been reported as viable candidates as active materials for the negative or positive electrode. Small particle sizes (for example, sizes in the nanometer range) generally can increase cycle life performance. They also can display very high irreversible capacity. However, small particle sizes also can result in very low volumetric energy density (for example, for the overall cell stack) due to the difficulty of packing the active material. Larger particle sizes, (for example, sizes in the micrometer or micron range) generally can result in higher density anode material. However, the expansion of the silicon active material can result in poor cycle life due to particle cracking. For example, silicon can swell in excess of 300% upon lithium insertion. Because of this expansion, anodes including silicon should be allowed to expand while maintaining electrical contact between the silicon particles.

As described herein and in U.S. patent application Ser. No. 13/008,800 (U.S. Pat. No. 9,178,208) and Ser. No. 13/601,976 (U.S. Patent Application Publication No. 2014/0170498), entitled “Composite Materials for Electrochemical Storage” and “Silicon Particles for Battery Electrodes,” respectively, the entireties of which are hereby incorporated by reference, certain embodiments utilize a method of creating monolithic, self-supported anodes using a carbonized polymer. Because the polymer is converted into an electrically conductive and electrochemically active matrix, the resulting electrode is conductive enough that a metal foil or mesh current collector can be omitted or minimized. The converted polymer also acts as an expansion buffer for silicon particles during cycling so that a high cycle life can be achieved. In certain embodiments, the resulting electrode is an electrode that is comprised substantially of active material. In further embodiments, the resulting electrode is substantially active material. The electrodes can have a high energy density of between about 500 mAh/g to about 3500 mAh/g that can be due to, for example, 1) the use of silicon, 2) elimination or substantial reduction of metal current collectors, and 3) being comprised entirely or substantially entirely of active material.

As described in U.S. patent application Ser. No. 14/821,586 (U.S. Patent Application Publication No. 2017/0040598), entitled “Surface Modification of Silicon Particles for Electrochemical Storage,” the entirety of which is hereby incorporated by reference, in certain embodiments, carbonized polymer may react with a native silicon oxide surface layer on the silicon particles. In some embodiments, the surface of the particles is modified to form a surface coating thereon, which may further act as an expansion buffer for silicon particles during cycling. The surface coating may include silicon carbide.

The composite materials described herein can be used as an anode in most conventional lithium ion batteries; they may also be used as the cathode in some electrochemical couples with additional additives. The composite materials can also be used in either secondary batteries (e.g., rechargeable) or primary batteries (e.g., non-rechargeable). In certain embodiments, the composite materials are self-supported structures. In further embodiments, the composite materials are self-supported monolithic structures. For example, a collector may be included in the electrode comprised of the composite material. In certain embodiments, the composite material can be used to form carbon structures discussed in U.S. patent application Ser. No. 12/838,368 (U.S. Patent Application Publication No. 2011/0020701), entitled “Carbon Electrode Structures for Batteries,” the entirety of which is hereby incorporated by reference. Furthermore, the composite materials described herein can be, for example, silicon composite materials, carbon composite materials, and/or silicon-carbon composite materials. As described in U.S. patent application Ser. No. 13/799,405 (U.S. Pat. No. 9,553,303), entitled “Silicon Particles for Battery Electrodes,” the entirety of which is hereby incorporated by reference, certain embodiments can further include composite materials including micron-sized silicon particles. For example, in some embodiments, the micron-sized silicon particles have nanometer-sized features on the surface. Silicon particles with such a geometry may have the benefits of both micron-sized silicon particles (e.g., high energy density) and nanometer-sized silicon particles (e.g., good cycling behavior). As used herein, the term “silicon particles” in general can include micron-sized silicon particles with or without nanometer-sized features.

Some composite materials may be provided on a current collector. In some embodiments, the composite material can be attached to a current collector using an attachment substance. The attachment substance and current collector may be any of those known in the art or yet to be developed. For example, some composite materials can be provided on a current collector as described in U.S. patent application Ser. No. 13/333,864 (U.S. Pat. No. 9,397,338), entitled “Electrodes, Electrochemical Cells, and Methods of Forming Electrodes and Electrochemical Cells;” or U.S. patent application Ser. No. 13/796,922 (U.S. Pat. No. 9,583,757), entitled “Electrodes, Electrochemical Cells, and Methods of Forming Electrodes and Electrochemical Cells,” each of which is incorporated by reference herein. Some anodes may be formed on a current collector, e.g., as described in U.S. patent application Ser. No. 15/471,860 (U.S. Patent Application Publication No. 2018/0287129), entitled “Methods of Forming Carbon-Silicon Composite Material on a Current Collector,” which is incorporated by reference herein.

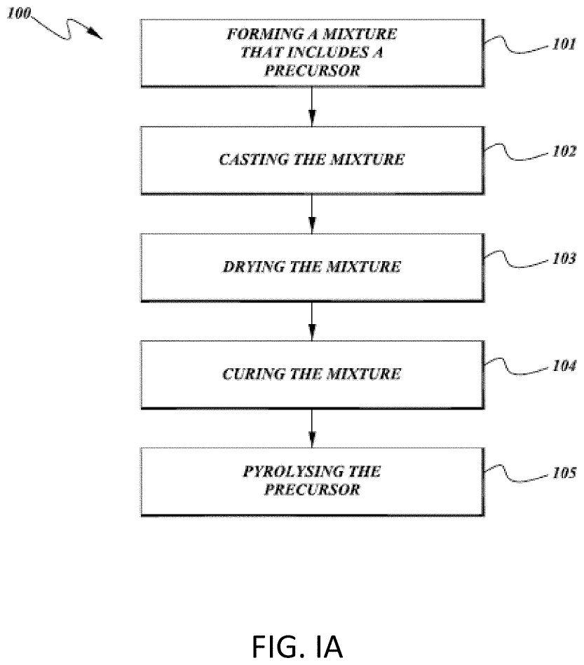

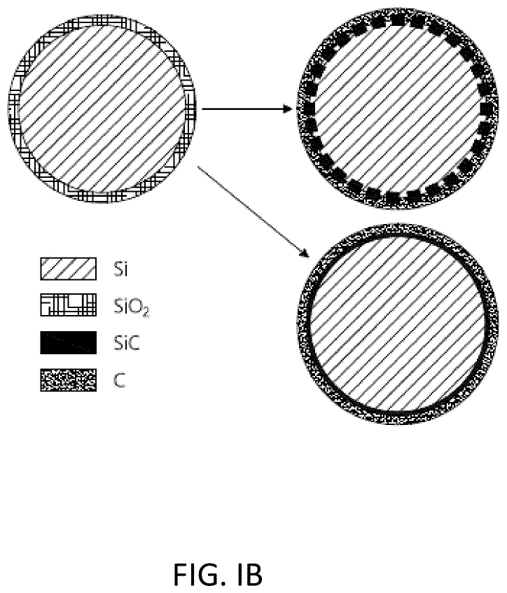

FIG. 1A illustrates one embodiment of a method of forming a composite material 100. For example, the method of forming a composite material can include forming a mixture including a precursor, block 101. The method can further include pyrolyzing the precursor to convert the precursor to a carbon phase. The precursor mixture may include carbon additives such as graphite active material, chopped or milled carbon fiber, carbon nanofibers, carbon nanotubes, and/or other carbons. After the precursor is pyrolyzed, the resulting carbon material can be a self-supporting monolithic structure. In certain embodiments, one or more materials are added to the mixture to form a composite material. For example, silicon particles can be added to the mixture. The carbonized precursor results in an electrochemically active structure that holds the composite material together. For example, the carbonized precursor can be a substantially continuous phase. The silicon particles, including micron-sized silicon particles with or without nanometer-sized features, may be distributed throughout the composite material. Advantageously, the carbonized precursor can be a structural material as well as an electro-chemically active and electrically conductive material. In certain embodiments, material particles added to the mixture are homogenously or substantially homogeneously distributed throughout the composite material to form a homogeneous or substantially homogeneous composite.

The mixture can include a variety of different components. The mixture can include one or more precursors. In certain embodiments, the precursor is a hydrocarbon compound. For example, the precursor can include polyacrylonitrile (PAN), a homopolymer or copolymer-mixture of monomers with acrylonitrile as the main monomer. As other examples, the precursor can include cellulose, glucose, sucrose, lignin, dextran, or a combination thereof. As other examples, the precursor can include one or more of polyamideimide, polyamic acid, polyimide, etc. In some instances, the precursor can include a dianhydride and/or a diamine. For example, the precursor can include pyromellitic dianhydride oxidianiline (PMDA-ODA), biphenyl tetracarboxylic acid dianhydride-p-phenylene diamine (BPDA-PDA), pyromellitic dianhydride-p-phenylene diamine (PMDA-PDA), or a combination thereof. Such monomers (e.g., PMDA-ODA, BPDA-PDA, PMDA-PDA, etc.) can be converted to polyamic acid by a polycondensation reaction. The polyamic acid can be imidized to form a polyimide during thermal curing, which may or may not include oxygen. Other precursors which can derive polyamic acid (e.g., by a reaction between dianhydride and a diamine/diisocyanate) can also be used. Other precursors can include phenolic resins (e.g., phenolic formaldehyde resin), epoxy resins, and/or other polymers.

The mixture can further include a solvent. For example, the solvent can be N-methyl-pyrrolidone (NMP). As another example, an aprotic solvent such as any one of or a mixture of dimethylformamide (DMF), dimethoxymethamphetamine (DMMA), dimethylacetamide (DMAc), dimethyl sulfoxide (DMSO), sulfolane, ethylene carbonate can be used to solubilize the precursor, e.g., to solubilize PAN. As another example, an aqueous solution of an inorganic salt such as lithium bromide, sodium thiocyanate, and/or zinc chloride can be used to solubilize the precursor, e.g., to solubilize PAN. In some instances, the aqueous solution can be concentrated, such as concentrated at about 10 wt. %, about 15 wt. %, about 20 wt. %, about 25 wt. %, about 30 wt. %, about 35 wt. %, about 40 wt. %, or concentrated in a range formed by any of such values (e.g., concentrated in a range from about 10 wt. % to about 30 wt. %, from about 10 wt. % to about 40 wt. %, from about 20 wt. % to 30 wt. %, from about 20 wt. % to about 40 wt. %, etc.). As another example, acids such as sulfuric and/or nitric acid can be used to solubilize the precursor, e.g., to solubilize PAN. In some instances, the acid can be concentrated, such as concentrated at about 10 wt. %, about 15 wt. %, about 20 wt. %, about 25 wt. %, about 30 wt. %, about 35 wt. %, about 40 wt. %, or concentrated in a range formed by any of such values (e.g., concentrated in a range from about 10 wt. % to about 30 wt. %, from about 10 wt. % to about 40 wt. %, from about 20 wt. % to 30 wt. %, from about 20 wt. % to about 40 wt. %, etc.). Other possible solvents include acetone, diethyl ether, gamma butyrolactone, isopropanol, dimethyl carbonate, ethyl carbonate, dimethoxyethane, ethanol, methanol, etc. Examples of precursor and solvent solutions include PI-2611 (HD Microsystems), PI-5878G (HD Microsystems) and VTEC PI-1388 (RBI, Inc.). PI-2611 is comprised of >60% n-methyl-2-pyrrolidone and 10-30% s-biphenyldianhydride/p-phenylenediamine. PI-5878G is comprised of >60% n-methylpyrrolidone, 10-30% polyamic acid of pyromellitic dianhydride/oxydianiline, 10-30% aromatic hydrocarbon (petroleum distillate) including 5-10% 1,2,4-trimethylbenzene. In certain embodiments, the amount of precursor in the solvent is about 10 wt. % to about 30 wt. %. Additional materials can also be included in the mixture. For example, as previously discussed, silicon particles or carbon particles including graphite active material, chopped or milled carbon fiber, carbon nanofibers, carbon nanotubes, graphene, and other conductive carbons can be added to the mixture. In addition, the mixture can be mixed to homogenize the mixture.

In certain embodiments, the mixture is cast on a substrate, block 102 in FIG. 1A. In some embodiments, casting includes using a gap extrusion, tape casting, or a blade casting technique. The blade casting technique can include applying a coating to the substrate by using a flat surface (e.g., blade) which is controlled to be a certain distance above the substrate. A liquid or slurry can be applied to the substrate, and the blade can be passed over the liquid to spread the liquid over the substrate. The thickness of the coating can be controlled by the gap between the blade and the substrate since the liquid passes through the gap. As the liquid passes through the gap, excess liquid can also be scraped off. For example, the mixture can be cast on a substrate comprising a polymer sheet, a polymer roll, and/or foils or rolls made of glass or metal. The mixture can then be dried to remove the solvent, block 103. For example, a polyamic acid and NMP solution can be dried at about 110° C. for about 2 hours to remove the NMP solution. The dried mixture coated on the substrate can form a green film. As described herein, in some embodiments, the green film can remain on the substrate to undergo the next step (e.g., pyrolysis). However, in other embodiments, the green film can be removed from the substrate. For example, an aluminum substrate can be etched away with HCl. Alternatively, the dried mixture can be removed from the substrate by peeling or otherwise mechanically removing the dried mixture from the substrate. In some embodiments, the substrate comprises polyethylene terephthalate (PET), including for example Mylar®. In some embodiments, the substrate can include cyclic olefin copolymer (COC). The substrate is not particularly limited. For example, any substrate can be used that can withstand the coating conditions (e.g., temperature and type of solvent used). In certain embodiments, the dried mixture is a film or sheet. In some embodiments, the dried mixture is optionally cured, block 104. In some embodiments, the dried mixture may be further dried. For example, the dried mixture can placed in a hot press (e.g., between graphite plates in an oven). A hot press can be used to further dry and/or cure and to keep the dried mixture flat. For example, the dried mixture from a polyamic acid and NMP solution can be hot pressed at about 200° C. for about 8 to 16 hours. Alternatively, the entire process including casting and drying can be done as a roll-to-roll process using standard film-handling equipment. The dried mixture can be rinsed to remove any solvents or etchants that may remain. For example, de-ionized (DI) water can be used to rinse the dried mixture. In certain embodiments, tape casting techniques can be used for the casting. In some embodiments, the mixture can be coated on a substrate by a slot die coating process (e.g., metering a constant or substantially constant weight and/or volume through a set or substantially set gap). In some other embodiments, there is no substrate for casting and the anode film does not need to be removed from any substrate. The dried mixture may be cut or mechanically sectioned into smaller pieces.

The mixture with or without the substrate can further go through pyrolysis to convert the polymer precursor to carbon, block 105. In certain embodiments, the mixture is pyrolysed in a reducing atmosphere. For example, an inert atmosphere, a vacuum and/or flowing argon, nitrogen, or helium gas can be used. In some embodiments, the mixture is heated to a temperature in a range from about from about 300° C. to about 1350° C. For example, the mixture can be heated to a temperature in a range from about 300° C. to about 1300° C., from about 350° C. to about 1300° C., from about 400° C. to about 1300° C., from about 450° C. to about 1300° C., from about 500° C. to about 1300° C., from about 350° C. to about 1350° C., from about 400° C. to about 1350° C., from about 450° C. to about 1350° C., from about 500° C. to about 1350° C., from about 700° C. to about 1350° C., from about 900° C. to about 1350° C., etc. In some instances, a mixture comprising PAN can be heated from about 350° C. to about 1350° C. In some instances, a mixture comprising polyamideimide (PAI) can be heated from about 400° C. (e.g., from about 420° C.) to about 1350° C. In some instances, a mixture comprising polyimide (PI) can be heated from about 500° C. to about 1350° C. Various examples are possible. For example, polyimide formed from polyamic acid can be carbonized at about 1175° C. for about one hour. In certain embodiments, the heat up rate and/or cool down rate of the mixture is about 10° C./min. A holder may be used to keep the mixture in a particular geometry. The holder can be graphite, metal, etc. In certain embodiments, the mixture is held flat. After the mixture is pyrolysed, tabs can be attached to the pyrolysed material to form electrical contacts. For example, nickel, copper or alloys thereof can be used for the tabs.

In certain embodiments, one or more of the methods described herein can be carried out in a continuous process. In certain embodiments, casting, drying, possibly curing and pyrolysis can be performed in a continuous process. For example, the mixture can be coated onto a glass or metal cylinder. The mixture can be dried while rotating on the cylinder to create a film. The film can be transferred as a roll or peeled and fed into another machine for further processing. Extrusion and other film manufacturing techniques known in industry could also be utilized prior to the pyrolysis step.

Pyrolysis of the precursor results in a carbon material (e.g., at least one carbon phase). In certain embodiments, the carbon material is a hard carbon. In some embodiments, the precursor is any material that can be pyrolysed to form a hard carbon. When the mixture includes one or more additional materials or phases in addition to the carbonized precursor, a composite material can be created. In particular, the mixture can include silicon particles, creating a silicon-carbon (e.g., at least one first phase comprising silicon and at least one second phase comprising carbon) or silicon-carbon-carbon (e.g., at least one first phase comprising silicon, at least one second phase comprising carbon, and at least one third phase comprising carbon) composite material.

Silicon particles can increase the specific lithium insertion capacity of the composite material. When silicon absorbs lithium ions, it experiences a large volume increase on the order of 300+ volume percent which can cause electrode structural integrity issues. In addition to volumetric expansion related problems, silicon is not inherently electrically conductive, but becomes conductive when it is alloyed with lithium (e.g., lithiation). When silicon de-lithiates, the surface of the silicon loses electrical conductivity. Furthermore, when silicon de-lithiates, the volume decreases which results in the possibility of the silicon particle losing contact with the matrix. The dramatic change in volume also results in mechanical failure of the silicon particle structure, in turn, causing it to pulverize. Pulverization and loss of electrical contact have made it a challenge to use silicon as an active material in lithium-ion batteries. A reduction in the initial size of the silicon particles can prevent further pulverization of the silicon powder as well as minimizing the loss of surface electrical conductivity. Furthermore, adding material to the composite that can elastically deform with the change in volume of the silicon particles can reduce the chance that electrical contact to the surface of the silicon is lost. For example, the composite material can include carbons such as graphite which contributes to the ability of the composite to absorb expansion and which is also capable of intercalating lithium ions adding to the storage capacity of the electrode (e.g., chemically active). Therefore, the composite material may include one or more types of carbon phases.

The shape of the silicon particles is not particularly limited. For example, the silicon particles can be spherical, wedge-shaped, irregularly shaped, or a combination thereof. The silicon particles can be untreated or can be surface modified to promote adhesion to the carbon precursor.

In some embodiments, the particle size (e.g., diameter or a largest dimension of the silicon particles) can be less than about 50 μm, less than about 40 μm, less than about 30 μm, less than about 20 μm, less than about 10 μm, less than about 1 μm, between about 10 nm and about 50 μm, between about 10 nm and about 40 μm, between about 10 nm and about 30 μm, between about 10 nm and about 20 μm, between about 0.1 μm and about 20 μm, between about 0.5 μm and about 20 μm, between about 1 μm and about 20 μm, between about 1 μm and about 15 μm, between about 1 μm and about 10 μm, between about 10 nm and about 10 μm, between about 10 nm and about 1 μm, less than about 500 nm, less than about 100 nm, about 100 nm, etc. All, substantially all, or at least some of the silicon particles may comprise the particle size (e.g., diameter or largest dimension) described above. For example, an average particle size (or the average diameter or the average largest dimension) or a median particle size (or the median diameter or the median largest dimension) of the silicon particles can be less than about 50 μm, less than about 40 μm, less than about 30 μm, less than about 20 μm, less than about 10 μm, less than about 1 μm, between about 10 nm and about 50 μm, between about 10 nm and about 40 μm, between about 10 nm and about 30 μm, between about 10 nm and about 20 μm, between about 0.1 μm and about 20 μm, between about 0.5 μm and about 20 μm, between about 1 μm and about 20 μm, between about 1 μm and about 15 μm, between about 1 μm and about 10 μm, between about 10 nm and about 10 μm, between about 10 nm and about 1 μm, less than about 500 nm, less than about 100 nm, about 100 nm, etc. In some embodiments, the silicon particles may have a distribution of particle sizes. For example, at least about 95%, at least about 90%, at least about 85%, at least about 80%, at least about 70%, or at least about 60% of the particles may have the particle size described herein.

The amount of silicon provided in the mixture or in the composite material can be greater than zero percent by weight of the mixture and/or composite material. In certain embodiments, the amount of silicon can be within a range of from about 0% to about 99% by weight of the composite material, including greater than about 0% to about 99% by weight, greater than about 0% to about 95% by weight, greater than about 0% to about 90%, greater than about 0% to about 35% by weight, greater than about 0% to about 25% by weight, from about 10% to about 35% by weight, at least about 30% by weight, from about 30% to about 99% by weight, from about 30% to about 95% by weight, from about 30% to about 90% by weight, from about 30% to about 80% by weight, at least about 50% by weight, from about 50% to about 99% by weight, from about 50% to about 95% by weight, from about 50% to about 90% by weight, from about 50% to about 80% by weight, from about 50% to about 70% by weight, at least about 60% by weight, from about 60% to about 99% by weight, from about 60% to about 95% by weight, from about 60% to about 90% by weight, from about 60% to about 80% by weight, at least about 70% by weight, from about 70% to about 99% by weight, from about 70% to about 95% by weight, from about 70% to about 90% by weight, etc. In various embodiments described herein, the amount of silicon can be 90% or greater by weight, e.g., about 90% or greater to about 95% by weight, about 90% or greater to about 97% by weight, about 90% or greater to about 99% by weight, about 92% or greater to about 99% by weight, about 95% or greater to about 99% by weight, about 97% or greater to about 99% by weight, etc.

Furthermore, the silicon particles may or may not be pure silicon. For example, the silicon particles may be substantially silicon or may be a silicon alloy. In one embodiment, the silicon alloy includes silicon as the primary constituent along with one or more other elements.

As described herein, micron-sized silicon particles can provide good volumetric and gravimetric energy density combined with good cycle life. In certain embodiments, to obtain the benefits of both micron-sized silicon particles (e.g., high energy density) and nanometer-sized silicon particles (e.g., good cycle behavior), silicon particles can have an average particle size or a median particle size in the micron range and a surface including nanometer-sized features. In some embodiments, the silicon particles can have an average particle size (e.g., average diameter or average largest dimension) or a median particle size (e.g., median diameter or median largest diameter) between about 0.1 μm and about 30 μm or between about 0.1 μm and all values up to about 30 μm. For example, the silicon particles can have an average particle size or a median particle size between about 0.1 μm and about 20 μm, between about 0.5 μm and about 25 μm, between about 0.5 μm and about 20 μm, between about 0.5 μm and about 15 μm, between about 0.5 μm and about 10 μm, between about 0.5 μm and about 5 μm, between about 0.5 μm and about 2 μm, between about 1 μm and about 20 μm, between about 1 μm and about 15 μm, between about 1 μm and about 10 μm, between about 5 μm and about 20 μm, etc. Thus, the average particle size or the median particle size can be any value between about 0.1 μm and about 30 μm, e.g., 0.1 μm, 0.5 μm, 1 μm, 5 μm, 6 μm, 7 μm, 8 μm, 9 μm, 10 μm, 15 μm, 20 μm, 25 μm, and 30 μm.

The nanometer-sized features can include an average feature size (e.g., an average diameter or an average largest dimension) between about 1 nm and about 1 μm, between about 1 nm and about 750 nm, between about 1 nm and about 500 nm, between about 1 nm and about 250 nm, between about 1 nm and about 100 nm, between about 10 nm and about 500 nm, between about 10 nm and about 250 nm, between about 10 nm and about 100 nm, between about 10 nm and about 75 nm, or between about 10 nm and about 50 nm. The features can include silicon.

The amount of carbon obtained from the precursor can be about 50 weight percent from polyamic acid. In certain embodiments, the amount of carbon obtained from the precursor in the composite material can be greater than 0% to about 95% by weight such as about 1% to about 95% by weight, about 1% to about 90% by weight, 1% to about 80% by weight, about 1% to about 70% by weight, about 1% to about 60% by weight, about 1% to about 50% by weight, about 1% to about 40% by weight, about 1% to about 30% by weight, about 5% to about 95% by weight, about 5% to about 90% by weight, about 5% to about 80% by weight, about 5% to about 70% by weight, about 5% to about 60% by weight, about 5% to about 50% by weight, about 5% to about 40% by weight, about 5% to about 30% by weight, about 10% to about 95% by weight, about 10% to about 90% by weight, about 10% to about 80% by weight, about 10% to about 70% by weight, about 10% to about 60% by weight, about 10% to about 50% by weight, about 10% to about 40% by weight, about 10% to about 30% by weight, about 10% to about 25% by weight, etc. For example, the amount of carbon obtained from the precursor can be about 1%, about 5%, about 10% by weight, about 15% by weight, about 20% by weight, about 25% by weight, etc. from the precursor. When the amount of silicon is 90% or greater by weight, the amount of carbon can be 10% or less by weight, e.g., about 0% or greater to about 3% by weight, about 0% or greater to about 5% by weight, about 0% or greater to about 10% by weight, about 1% or greater to about 3% by weight, about 1% or greater to about 5% by weight, about 1% or greater to about 8% by weight, about 1% or greater to about 10% by weight, about 5% or greater to about 10% by weight, etc.

The carbon from the precursor can be hard carbon (e.g., a glassy carbon). Hard carbon can be a carbon that does not convert into graphite even with heating in excess of 2800 degrees Celsius. Precursors that melt or flow during pyrolysis convert into soft carbons and/or graphite with sufficient temperature and/or pressure. Hard carbon may be selected since soft carbon precursors may flow and soft carbons and graphite are mechanically weaker than hard carbons. Other possible hard carbon precursors can include phenolic resins, epoxy resins, and other polymers that have a very high melting point or are crosslinked. In some embodiments, the amount of hard carbon in the composite material can have a value within a range of greater than 0% to about 95% by weight such as about 1% to about 95% by weight, about 1% to about 90% by weight, about 1% to about 80% by weight, about 1% to about 70% by weight, about 1% to about 60% by weight, about 1% to about 50% by weight, about 1% to about 40% by weight, about 1% to about 30% by weight, about 5% to about 95% by weight, about 5% to about 90% by weight, about 5% to about 80% by weight, about 5% to about 70% by weight, about 5% to about 60% by weight, about 5% to about 50% by weight, about 5% to about 40% by weight, about 5% to about 30% by weight, about 10% to about 95% by weight, about 10% to about 90% by weight, about 10% to about 80% by weight, about 10% to about 70% by weight, about 10% to about 60% by weight, about 10% to about 50% by weight, about 10% to about 40% by weight, about 10% to about 30% by weight, about 10% to about 25% by weight, etc. In some embodiments, the amount of hard carbon in the composite material can be about 1% by weight, about 5% by weight, about 10% by weight, about 20% by weight, about 30% by weight, about 40% by weight, about 50% by weight, or more than about 50% by weight. When the amount of silicon is 90% or greater by weight, the amount of hard carbon can be 10% or less by weight, e.g., about 0% or greater to about 3% by weight, about 0% or greater to about 5% by weight, about 0% or greater to about 10% by weight, about 1% or greater to about 3% by weight, about 1% or greater to about 5% by weight, about 1% or greater to about 8% by weight, about 1% or greater to about 10% by weight, about 5% or greater to about 10% by weight, etc.

In certain embodiments, the hard carbon phase is substantially amorphous. In other embodiments, the hard carbon phase is substantially crystalline. In further embodiments, the hard carbon phase includes amorphous and crystalline carbon. The hard carbon phase can be a matrix phase in the composite material. The hard carbon can also be embedded in the pores of the additives including silicon. The hard carbon may react with some of the additives to create some materials at interfaces. For example, there may be a silicon carbide layer between silicon particles and the hard carbon.

In order to produce electrodes with about 90% or greater by weight of silicon, the amount of carbon can be less than or equal to about 10% by weight (e.g., the silicon to carbon precursor ratio can be high). To produce such electrodes, low char yield polymers such as PAN can be used for the carbon precursor. Other low char yield natural polymers, such as cellulose, glucose, sucrose, lignin, and/or dextran, or synthetic polymers, such as polyimides, phenol formaldehyde resins (e.g., SU-8), etc. can be used. In some instances, the low char yield polymer can be heat treated under inert atmospheres to certain temperatures. In some embodiments, a partial oxidation process is used such that the char yield can be low.

As described herein, some embodiments can be pyrolyzed on a substrate (e.g., such that the green film is not self-standing when undergoing heat treatment). Substrates with a low char yield such as acetal, polypropylene, polyethylene, polystyrene, etc. may in some embodiments leave about 0% or greater to about 5% carbon (e.g., only 2% carbon) upon pyrolysis and can be used as a sacrificial substrate. The formulations can be adjusted to provide a silicon to carbon precursor ratio that is higher than if a substrate were not used, allowing flexibility to use precursors whose char yield can be higher than, e.g., PAN.

In some embodiments, the green film can be oxidized, partially or completely under an air/oxygen supply prior to carbonization/pyrolysis in inert atmospheres such as nitrogen, argon, vacuum, etc. The level of oxidation can be controlled such that the film does not reflow at any stage during the heat treatment, maintaining the coating shape integrity. The level of oxidation can be controlled by stacking the green films (single or multi-layer), dimensions of the green films, degree of convection in the oven, and compressive pressure from the weight on top of the stack. Oxidation of the green films and subsequent heat treatment can be such that the total char yield is between about 0% to about 60% from the green films to the carbon-silicon composite materials. For example, the char yield can be from about 0% or greater to about 30%, from about 0% or greater to about 40%, from about 0% or greater to about 50%, from about 1% or greater to about 30%, from about 1% or greater to about 40%, from about 1% or greater to about 50%, from about 1% or greater to about 60%, etc.

According to various embodiments, a composite material film can comprise about 90% to about 99% by weight silicon particles, and greater than 0% and less than or equal to about 10% by weight of one or more types of carbon phases. At least one of the carbon phases can comprise hard carbon as a matrix phase that holds the composite material film together such that the silicon particles are distributed throughout the composite material film. In some instances, the amount of silicon can be about 90% or greater to about 95% by weight, about 90% or greater to about 97% by weight, about 90% or greater to about 99% by weight, about 92% or greater to about 99% by weight, about 95% or greater to about 99% by weight, about 97% or greater to about 99% by weight, etc.

In certain embodiments heating the mixture to a desired pyrolysis temperature may further result in the surface modification of silicon particles present in the mixture. In some embodiments pyrolysis of the mixture may result in the formation of a surface coating on at least 50% of the silicon particles present in the mixture. In some embodiments pyrolysis of the mixture may result in the formation of a surface coating on at least 60%, 70%, 80%, 90% or 99% of the silicon particles present in the mixture. In some embodiments, the surface coatings form a substantially continuous layer on the silicon particles.

In some embodiments, the carbonized precursor or resin may contact the surface of the silicon particles. In certain embodiments, the carbonized precursor in contact with the silicon particle surface may be one or more types of carbon phases resulting from pyrolysis of the precursor. The one or more types of carbon phases of the carbonized precursor in contact with the silicon particle surface may react with the silicon particles during pyrolysis to thereby form silicon carbide on the silicon particle surface. Therefore, in some embodiments, the surface coatings may comprise carbon, silicon carbide, and/or a mixture of carbon and silicon carbide.

In some embodiments, as described further below, the silicon particles present in the mixture may comprise a native silicon oxide (SiO, SiO₂, SiOx) surface layer. In certain embodiments, the carbonized precursor in contact with the silicon particle surface may react with the naturally occurring native silicon oxide surface layer to form silicon carbide. In some embodiments the carbonized precursor in contact with the silicon particle surface may react with substantially all of the native silicon oxide layer to form silicon carbide. Therefore, the surface coatings on the silicon particles may comprise, in some embodiments, carbon and silicon carbide, wherein the surface coating is substantially free of silicon oxide. In some embodiments a first portion of the surface coatings may comprise silicon carbide while a second portion may comprise a mixture of silicon carbide and carbon. In some other embodiments, the carbonized precursor in contact with the silicon particle surface may not fully convert the native silicon oxide layer to silicon carbide, and the resultant surface coating or coatings may comprise carbon, silicon carbide, and one or more silicon oxides, such as SiO, SiO₂, and SiOₓ. In some embodiments, the carbonized precursor in contact with the silicon particle surface may be completely reacted, resulting in surface coatings that comprise silicon carbide. In some embodiments substantially all of the surface coatings may comprise silicon carbide. In some embodiments, such surface coatings may be substantially free of silicon oxide and/or carbon.

In certain embodiments, the pyrolyzed mixture can include silicon particles having carbon and/or silicon carbide surface coatings creating a silicon-carbon-silicon carbide (e.g., at least one first phase comprising silicon, at least one second phase comprising carbon, and at least a third phase comprising silicon carbide) or silicon-carbon-carbon-silicon carbide (e.g., at least one first phase comprising silicon, at least one second phase comprising carbon, at least one third phase comprising carbon, and at least a fourth phase comprising silicon carbide) composite material.

Additionally, surface coatings on the silicon particles described herein can help to constrain the outward expansion of the silicon particle during lithiation. By constraining outward particle expansion during lithiation, the surface coatings can help prevent mechanical failure of the silicon particles and ensure good electrical contact. The surface coatings can further enhance the electronic charge transfer within the electrode. Controlled and optimized surface modification of silicon particles in the anode may also significantly improve capacity retention during cycling of an associated battery cell.

Moreover, the surface coatings substantially affect the reactions that occur between the anode materials and the electrolyte within a battery. The surface coatings can help reduce unwanted reactions. During high temperature pyrolysis, the formed surface coatings and the removal of unwanted native oxide (SiO₂) via conversion into more stable and unreactive SiC can provide higher reversible capacity with minimized irreversible capacity loss. Irreversible capacity loss can be due to formation and build-up of a solid electrolyte interface (SEI) layer that consumes lithium. This becomes a more prominent issue for silicon particles because nano- and micro-scale silicon particles have large surface areas and larger silicon particles tend to pulverize during lithiation and delithiation which can introduce additional particle surface area. Additionally, irreversible capacity loss can be due to the reaction of lithium with undesirable native silicon oxides (Equation 1) which are unavoidable during processing and storage of silicon anode materials.

SiOₓ+yLi+ye→Si+Li_{y}Oₓ (Equation 1)

Therefore, the surface modification of the silicon particles by carbon and/or silicon carbide may aid in the formation of a relatively stable solid electrolyte interface layer and may reduce or eliminate the undesirable reaction of lithium with native silicon oxides on the Si particle surface (Equation 1).

FIG. 1B is a schematic illustration of the formation of silicon carbide on a silicon particle as described above. Initially, a silicon particle comprising a native silicon oxide surface layer is provided in a mixture comprising a precursor as described above. In some embodiments, the mixture is pyrolyzed in a reducing atmosphere. For example, a reducing atmosphere, a vacuum and/or flowing gas including H₂, CO, or hydrocarbon gas can be used. In some embodiments, the mixture is heated to about 500° C. to about 1350° C. In some embodiments, the mixture is heated to about 800° C. to about 1200° C. In some embodiments, the mixture is heated to about 1175° C.

The pyrolyzed precursor in contact with the surface of the silicon particle reacts with the native silicon oxide layer of the silicon particle to form silicon carbide. The carbonized precursor in contact with the silicon particle surface is depicted here as continuous and conformal, but may not be continuous or conformal in some other embodiments. Further, in some embodiments, the silicon carbide layer formed from the reaction between the native silicon oxide layer and the carbonized precursor in contact with the silicon particle surface may take the form of a coating or dispersion within the composite anode film. As shown in FIG. 1B, in some embodiments the silicon carbide may not be continuous or conformal on the silicon particle, however in some other embodiments the silicon carbide may be a continuous and/or conformal coating.

In certain embodiments, graphite particles are added to the mixture. Advantageously, graphite can be an electrochemically active material in the battery as well as an elastic deformable material that can respond to volume change of the silicon particles. Graphite is the preferred active anode material for certain classes of lithium-ion batteries currently on the market because it has a low irreversible capacity. Additionally, graphite is softer than hard carbon and can better absorb the volume expansion of silicon additives. In certain embodiments, the particle size (e.g., a diameter or a largest dimension) of the graphite particles can be between about 0.5 microns and about 20 microns. All, substantially all, or at least some of the graphite particles may comprise the particle size (e.g., diameter or largest dimension) described herein. In some embodiments, an average or median particle size (e.g., diameter or largest dimension) of the graphite particles can be between about 0.5 microns and about 20 microns. In some embodiments, the graphite particles may have a distribution of particle sizes. For example, at least about 95%, at least about 90%, at least about 85%, at least about 80%, at least about 70%, or at least about 60% of the particles may have the particle size described herein. In certain embodiments, the composite material can include graphite particles in an amount greater than 0% and less than about 80% by weight, including from about 40% to about 75% by weight, from about 5% to about 30% by weight, from about 5% to about 25% by weight, from about 5% to about 20% by weight, from about 5% to about 15% by weight, etc. When the amount of silicon is 90% or greater by weight, the amount of graphite can be 10% or less by weight, e.g., about 0% or greater to about 3% by weight, about 0% or greater to about 5% by weight, about 0% or greater to about 10% by weight, about 1% or greater to about 3% by weight, about 1% or greater to about 5% by weight, about 1% or greater to about 8% by weight, about 1% or greater to about 10% by weight, about 5% or greater to about 10% by weight, etc.

In certain embodiments, conductive particles which may also be electrochemically active are added to the mixture. Such particles can enable both a more electronically conductive composite as well as a more mechanically deformable composite capable of absorbing the large volumetric change incurred during lithiation and de-lithiation. In certain embodiments, a particle size (e.g., diameter or a largest dimension) of the conductive particles can be between about 10 nanometers and about 7 micrometers. All, substantially all, or at least some of the conductive particles may comprise the particle size (e.g., diameter or largest dimension) described herein. In some embodiments, an average or median particle size (e.g., diameter or largest dimension) of the conductive particles can be between about 10 nm and about 7 micrometers. In some embodiments, the conductive particles may have a distribution of particle sizes. For example, at least about 95%, at least about 90%, at least about 85%, at least about 80%, at least about 70%, or at least about 60% of the particles may have the particle size described herein.

In certain embodiments, the mixture can include conductive particles in an amount greater than zero and up to about 80% by weight. In further embodiments, the composite material can include about 45% to about 80% by weight. The conductive particles can be conductive carbon including carbon blacks, carbon fibers, carbon nanofibers, carbon nanotubes, etc. Many carbons that are considered as conductive additives that are not electrochemically active become active once pyrolyzed in a polymer matrix. Alternatively, the conductive particles can be metals or alloys including copper, nickel, or stainless steel. When the amount of silicon is 90% or greater by weight, the amount of conductive particles can be 10% or less by weight, e.g., about 0% or greater to about 3% by weight, about 0% or greater to about 5% by weight, about 0% or greater to about 10% by weight, about 1% or greater to about 3% by weight, about 1% or greater to about 5% by weight, about 1% or greater to about 8% by weight, about 1% or greater to about 10% by weight, about 5% or greater to about 10% by weight, etc.

In certain embodiments, an electrode can include a composite material described herein. For example, a composite material can form a self-supported monolithic electrode. The pyrolysed carbon phase (e.g., hard carbon phase) of the composite material can hold together and structurally support the particles that were added to the mixture. In some instances, the hard carbon phase can be a matrix phase (e.g., glassy in nature) that is a substantially continuous phase. The silicon particles can be homogeneously distributed throughout the hard carbon. In certain embodiments, the self-supported monolithic electrode does not include a separate substrate, collector layer, and/or other supportive structures. In some embodiments, the composite material and/or electrode does not include a polymer beyond trace amounts that remain after pyrolysis of the precursor. In further embodiments, the composite material and/or electrode does not include a non-electrically conductive binder. The composite material may also include porosity, such as about 1% to about 70% or about 5% to about 50% by volume porosity. For example, the porosity can be about 5% to about 40% by volume porosity.

In some embodiments, the composite material (with or without a substrate) can be attached to a current collector. For example, the composite material can be laminated on a current collector using an electrode attachment substance (e.g., a polymer adhesive). In some embodiments, the composite material may also be formed into a powder. For example, the composite material can be ground into a powder. The composite material powder can be used as an active material for an electrode. For example, the composite material powder can be deposited on a collector in a manner similar to making a conventional electrode structure, as known in the industry.

In certain embodiments, an electrode in a battery or electrochemical cell can include a composite material, including composite material with the silicon particles described herein. For example, the composite material can be used for the anode and/or cathode. In some instances, a battery can include an anode, a cathode, and an electrolyte. The anode can comprise the composite material described herein. The cathode is not particularly limited and can comprise nickel cobalt manganese (NCM), lithium cobalt oxide (LCO), nickel cobalt aluminum oxide (NCAO), lithium manganese oxide (LMO), lithium manganese oxide (LMO), lithium nickel manganese oxide (LNMO), lithium iron phosphate (LFP), etc. The electrolyte can be in a liquid or solid state. In certain embodiments, the battery is a lithium ion battery. In further embodiments, the battery is a secondary battery, or in other embodiments, the battery is a primary battery.

Furthermore, the full capacity of the composite material may not be utilized during use of the battery to improve life of the battery (e.g., number charge and discharge cycles before the battery fails or the performance of the battery decreases below a usability level). For example, a composite material with about 70% by weight silicon particles, about 20% by weight carbon from a precursor, and about 10% by weight graphite may have a maximum gravimetric capacity of about 3000 mAh/g, while the composite material may only be used up to an gravimetric capacity of about 550 to about 1500 mAh/g. Although, the maximum gravimetric capacity of the composite material may not be utilized, using the composite material at a lower capacity can still achieve a higher capacity than certain lithium ion batteries. In certain embodiments, the composite material is used or only used at a gravimetric capacity below about 70% of the composite material's maximum gravimetric capacity. For example, the composite material is not used at a gravimetric capacity above about 70% of the composite material's maximum gravimetric capacity. In further embodiments, the composite material is used or only used at a gravimetric capacity below about 50% of the composite material's maximum gravimetric capacity or below about 30% of the composite material's maximum gravimetric capacity.

### Silicon Particles

Described herein are silicon particles for use in battery electrodes (e.g., anodes and cathodes). Anode electrodes currently used in the rechargeable lithium-ion cells typically have a specific capacity of approximately 200 milliampere hours per gram (including the metal foil current collector, conductive additives, and binder material). Graphite, the active material used in most lithium ion battery anodes, has a theoretical energy density of 372 milliampere hours per gram (mAh/g). In comparison, silicon has a high theoretical capacity of 4200 mAh/g. Silicon, however, swells in excess of 300% upon lithium insertion. Because of this expansion, anodes including silicon should be able to expand while allowing for the silicon to maintain electrical contact with the silicon.

Some embodiments provide silicon particles that can be used as an electro-chemically active material in an electrode. The electrode may include binders and/or other electro-chemically active materials in addition to the silicon particles. For example, the silicon particles described herein can be used as the silicon particles in the composite materials described herein. In another example, an electrode can have an electro-chemically active material layer on a current collector, and the electro-chemically active material layer includes the silicon particles. The electro-chemically active material may also include one or more types of carbon.

Advantageously, the silicon particles described herein can improve performance of electro-chemically active materials such as improving capacity and/or cycling performance. Furthermore, electro-chemically active materials having such silicon particles may not significantly degrade as a result of lithiation of the silicon particles.

In certain embodiments, the silicon particles can have an average particle size, for example an average diameter or an average largest dimension, between about 10 nm and about 40 μm as described herein. Further embodiments can include average particle sizes of between about 1 μm and about 15 μm, between about 10 nm and about 1 μm, and between about 100 nm and about 10 μm. Silicon particles of various sizes can be separated by various methods such as by air classification, sieving or other screening methods. For example, a mesh size of 325 can be used separate particles that have a particle size less than about 44 μm from particles that have a particle size greater than about 44 μm.

Furthermore, the silicon particles may have a distribution of particle sizes. For example, at least about 90% of the particles may have particle size, for example a diameter or a largest dimension, between about 10 nm and about 40 μm, between about 1 μm and about 15 μm, between about 10 nm and about 1 μm, and/or larger than 200 nm.

In some embodiments, the silicon particles may have an average surface area per unit mass of between about 1 to about 100 m²/g, about 1 to about 80 m²/g, about 1 to about 60 m²/g, about 1 to about 50 m²/g, about 1 to about 30 m²/g, about 1 to about 10 m²/g, about 1 to about 5 m²/g, about 2 to about 4 m²/g, or less than about 5 m²/g.

In certain embodiments, the silicon particles are at least partially crystalline, substantially crystalline, and/or fully crystalline. Furthermore, the silicon particles may be substantially pure silicon.

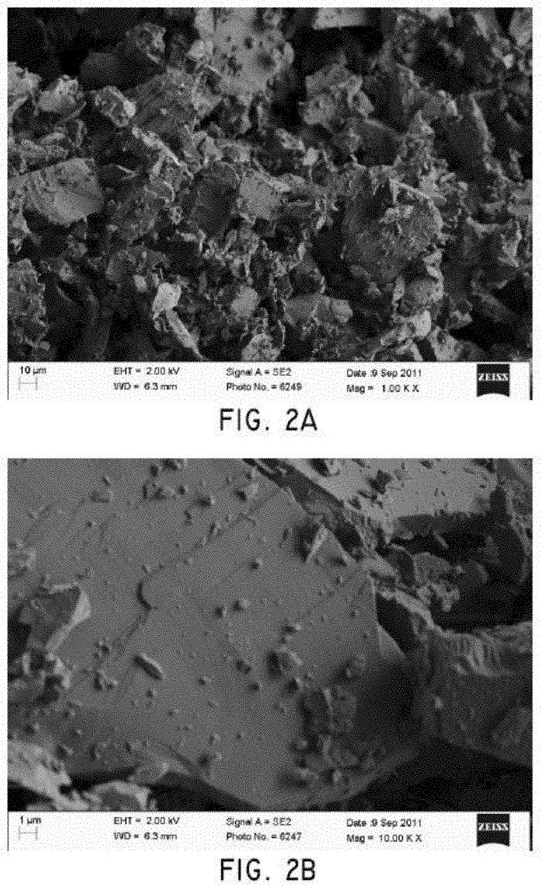

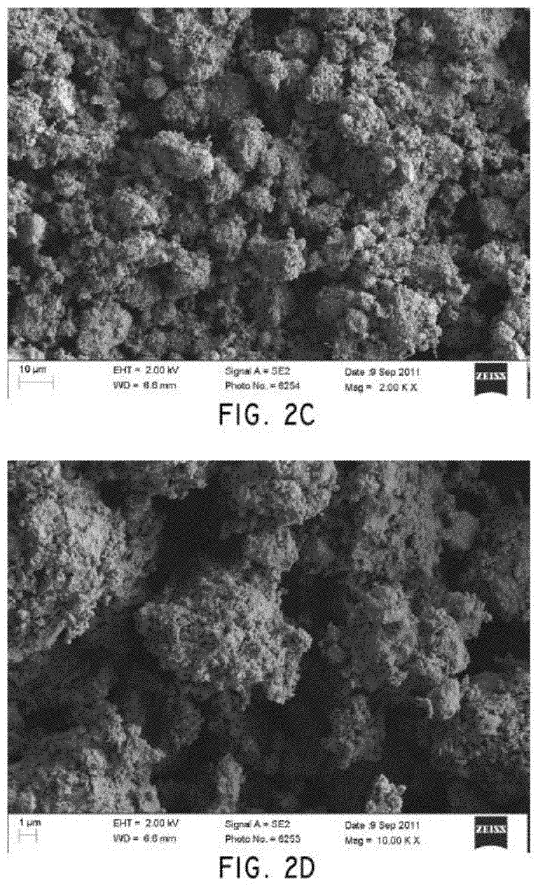

Compared with the silicon particles used in conventional electrodes, the silicon particles described herein for some embodiments can generally have a larger average particle size. In some embodiments, the average surface area of the silicon particles described herein can be generally smaller. Without being bound to any particular theory, the lower surface area of the silicon particles described herein may contribute to the enhanced performance of electrochemical cells. Typical lithium ion type rechargeable battery anodes would contain nano-sized silicon particles. In an effort to further increase the capacity of the cell, smaller silicon particles (such as those in nano-size ranges) are being used for making the electrode active materials. In some cases, the silicon particles are milled to reduce the size of the particles. Sometimes the milling may result in roughened or scratched particle surface, which also increases the surface area. However, the increased surface area of silicon particles may actually contribute to increased degradation of electrolytes, which lead to increased irreversible capacity loss. FIGS. 2A and 2B are SEM micrographs of an example embodiment of silicon particles milled-down from larger silicon particles. As shown in the figures, certain embodiments may have a roughened surface.

As described herein, certain embodiments include silicon particles with surface roughness in nanometer-sized ranges, e.g., micron-sized silicon particles with nanometer-sized features on the surface. FIGS. 2C and 2D are SEM micrographs of an example embodiment of such silicon particles. Various such silicon particles can have an average particle size (e.g., an average diameter or an average largest dimension) in the micron range (e.g., as described herein, between about 0.1 μm and about 30 μm) and a surface including nanometer-sized features (e.g., as described herein, between about 1 nm and about 1 μm, between about 1 nm and about 750 nm, between about 1 nm and about 500 nm, between about 1 nm and about 250 nm, between about 1 nm and about 100 nm, between about 10 nm and about 500 nm, between about 10 nm and about 250 nm, between about 10 nm and about 100 nm, between about 10 nm and about 75 nm, or between about 10 nm and about 50 nm). The features can include silicon.

Compared to the example embodiment shown in FIGS. 2A and 2B, silicon particles with a combined micron/nanometer-sized geometry (e.g., FIGS. 2C and 2D) can have a higher surface area than milled-down particles. Thus, the silicon particles to be used can be determined by the desired application and specifications.

Even though certain embodiments of silicon particles have nanometer-sized features on the surface, the total surface area of the particles can be more similar to micron-sized particles than to nanometer-sized particles. For example, micron-sized silicon particles (e.g., silicon milled-down from large particles) typically have an average surface area per unit mass of over about 0.5 m²/g and less than about 2 m²/g (for example, using Brunauer Emmet Teller (BET) particle surface area measurements), while nanometer-sized silicon particles typically have an average surface area per unit mass of above about 100 m²/g and less than about 500 m²/g. Certain embodiments described herein can have an average surface area per unit mass between about 1 m²/g and about 30 m²/g, between about 1 m²/g and about 25 m²/g, between about 1 m²/g and about 20 m²/g, between about 1 m²/g and about 10 m²/g, between about 2 m²/g and about 30 m²/g, between about 2 m²/g and about 25 m²/g, between about 2 m²/g and about 20 m²/g, between about 2 m²/g and about 10 m²/g, between about 3 m²/g and about 30 m²/g, between about 3 m²/g and about 25 m²/g, between about 3 m²/g and about 20 m²/g, between about 3 m²/g and about 10 m²/g (e.g., between about 3 m²/g and about 6 m²/g), between about 5 m²/g and about 30 m²/g, between about 5 m²/g and about 25 m²/g, between about 5 m²/g and about 20 m²/g, between about 5 m²/g and about 15 m²/g, or between about 5 m²/g and about 10 m²/g.

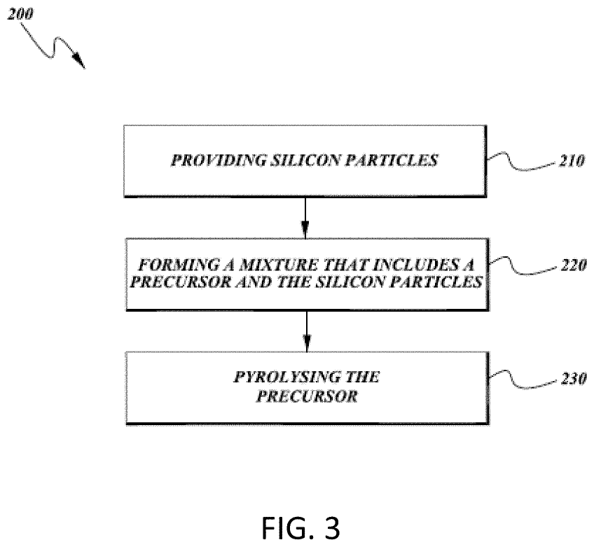

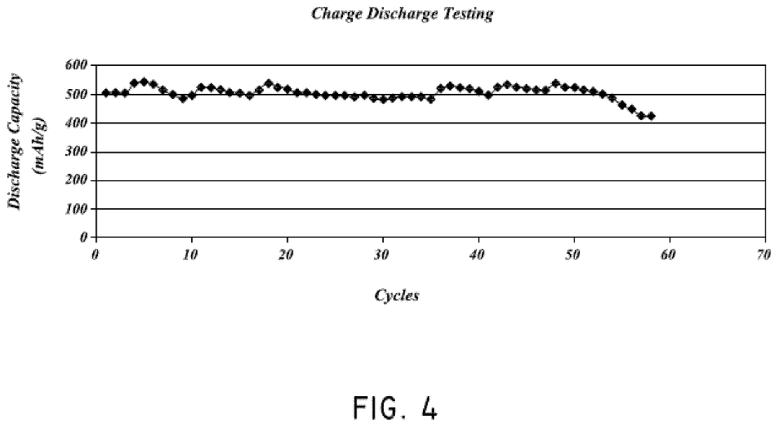

Various examples of micron-sized silicon particles with nanometer-sized features can be used to form certain embodiments of composite materials as described herein. For example, FIG. 3 illustrates an example method 200 of forming certain embodiments of the composite material. The method 200 includes providing a plurality of silicon particles (for example, silicon particles having an average particle size between about 0.1 μm and about 30 μm and a surface including nanometer-sized features), block 210. The method 200 further includes forming a mixture that includes a precursor and the plurality of silicon particles, block 220. The method 200 further includes pyrolysing the precursor, block 230, to convert the precursor into one or more types of carbon phases to form the composite material.

With respect to block 210 of method 200, silicon with the characteristics described herein can be synthesized as a product or byproduct of a Fluidized Bed Reactor (FBR) process. For example, in the FBR process, useful material can be grown on seed silicon material. Typically, particles can be removed by gravity from the reactor. Some fine particulate silicon material can exit the reactor from the top of the reactor or can be deposited on the walls of the reactor. The material that exits the top of the reactor or is deposited on the walls of the reactor (e.g., byproduct material) can have nanoscale features on a microscale particle. In some such processes, a gas (e.g., a nitrogen carrier gas) can be passed through the silicon material. For example, the silicon material can be a plurality of granular silicon. The gas can be passed through the silicon material at high enough velocities to suspend the solid silicon material and make it behave as a fluid. The process can be performed under an inert atmosphere, e.g., under nitrogen or argon. In some embodiments, silane gas can also be used, for example, to allow for metal silicon growth on the surface of the silicon particles. The growth process from a gas phase can give the silicon particles the unique surface characteristics, e.g., nanometer-sized features. Since silicon usually cleaves in a smooth shape, e.g., like glass, certain embodiments of silicon particles formed using the FBR process can advantageously acquire small features, e.g., in nanometer-sized ranges, that may not be as easily achievable in some embodiments of silicon particles formed by milling from larger silicon particles.

In addition, since the FBR process can be under an inert atmosphere, very high purity particles (for example, higher than 99.9999% purity) can be achieved. In some embodiments, purity of between about 99.9999% and about 99.999999% can be achieved. In some embodiments, the FBR process can be similar to that used in the production of solar-grade polysilicon while using 85% less energy than the traditional Siemens method, where polysilicon can be formed as trichlorosilane decomposes and deposits additional silicon material on high-purity silicon rods at 1150° C. Because nanometer-sized silicon particles have been shown to increase cycle life performance in electrochemical cells, micron-sized silicon particles have not been contemplated for use as electrochemical active materials in electrochemical cells.

With respect to blocks 220 and 230 of method 200, forming a mixture that includes a precursor and the plurality of silicon particles, block 220, and pyrolysing the precursor, block 230, to convert the precursor into one or more types of carbon phases to form the composite material can be similar to blocks 101 and 105 respectively, of method 100 described herein. In some embodiments, pyrolysing (e.g., at about 900° C. to about 1350° C.) occurs at temperatures below the melting point of silicon (e.g., at about 1414° C.) without affecting the nanometer- sized features of the silicon particles.

In accordance with certain embodiments described herein, certain micron-sized silicon particles with nanometer surface feature can achieve high energy density, and can be used in composite materials and/or electrodes for use in electro-chemical cells to improve performance during cell cycling.

### EXAMPLES

The below example processes for anode fabrication generally include mixing components together, casting those components onto a removable substrate, drying, curing, removing the substrate, then pyrolyzing the resulting samples. N-Methyl-2-pyrrolidone (NMP) was typically used as a solvent to modify the viscosity of any mixture and render it castable using a doctor blade approach.

### Example 1

In Example 1, a polyimide liquid precursor (PI 2611 from HD Microsystems corp.), graphite particles (SLP30 from Timcal corp.), conductive carbon particles (Super P from Timcal corp.), and silicon particles (from Alfa Aesar corp.) were mixed together for 5 minutes using a Spex 8000D machine in the weight ratio of 200:55:5:20. The mixture was then cast onto aluminum foil and allowed to dry in a 90° C. oven, to drive away solvents, e.g., NMP. This is followed by a curing step at 200° C. in a hot press, under negligible pressure, for at least 12 hours. The aluminum foil backing was then removed by etching in a 12.5% HCl solution. The remaining film was then rinsed in DI water, dried and then pyrolyzed around an hour at 1175° C. under argon flow. The process resulted in a composition of 15.8% of PI 2611 derived carbon, 57.9% of graphite particles, 5.3% of carbon resulting from Super P, and 21.1% of silicon by weight.

The resulting electrodes were then tested in a pouch cell configuration against a lithium NMC oxide cathode. A typical cycling graph is shown in FIG. 4.

### Example 2

In Example 2, silicon particles (from EVNANO Advanced Chemical Materials Co. Ltd.) were initially mixed with NMP using a Turbula mixer for a duration of one hour at a 1:9 weight ratio. Polyimide liquid precursor (PI 2611 from HD Microsystems corp.), graphite particles (SLP30 from Timcal corp.), and carbon nanofibers (CNF from Pyrograf corp.) were then added to the Si:NMP mixture in the weight ratio of 200:55:5:200 and vortexed for around 2 minutes. The mixture was then cast onto aluminum foil that was covered by a 21 μm thick copper mesh. The samples were then allowed to dry in a 90° C. oven to drive away solvents, e.g., NMP. This was followed by a curing step at 200° C. in a hot press, under negligible pressure, for at least 12 hours. The aluminum foil backing was then removed by etching in a 12.5% HCl solution. The remaining film was then rinsed in DI water, dried and then pyrolyzed for around an hour at 1000° C. under argon. The process resulted in a composition of 15.8% of PI 2611 derived carbon, 57.9% of graphite particles, 5.3% of CNF, and 21.1% of silicon by weight.

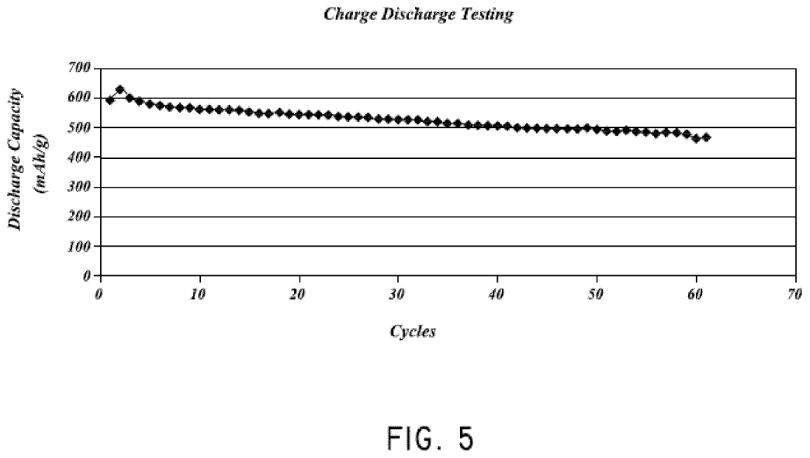

The resulting electrodes were then tested in a pouch cell configuration against a lithium NMC oxide cathode. A typical cycling graph is shown in FIG. 5.

### Example 3

In Example 3, polyimide liquid precursor (PI 2611 from HD Microsystems corp.), and 325 mesh silicon particles (from Alfa Aesar corp.) were mixed together using a Turbula mixer for a duration of 1 hour in the weight ratios of 40:1. The mixture was then cast onto aluminum foil and allowed to dry in a 90° C. oven to drive away solvents, e.g., NMP. This was followed by a curing step at 200° C. in a hot press, under negligible pressure, for at least 12 hours. The aluminum foil backing was then removed by etching in a 12.5% HCl solution. The remaining film was then rinsed in DI water, dried and then pyrolyzed around an hour at 1175° C. under argon flow. The process resulted in a composition of 75% of PI 2611 derived carbon and 25% of silicon by weight.

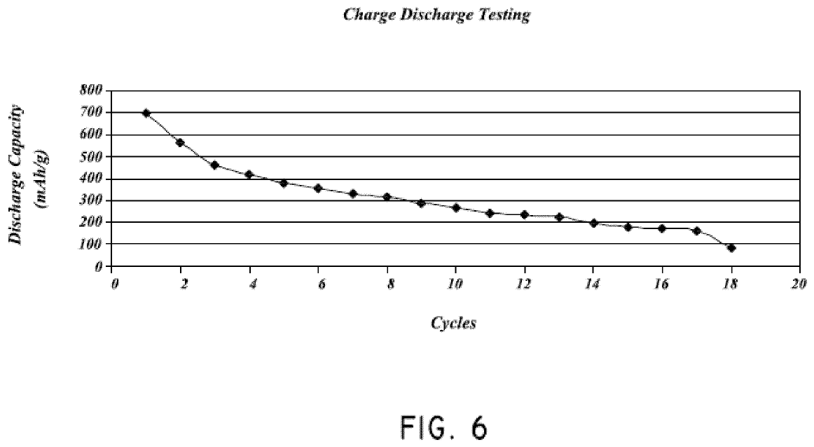

The resulting electrodes were then tested in a pouch cell configuration against a lithium NMC Oxide cathode. A typical cycling graph is shown in FIG. 6.

### Example 4

In Example 4, silicon microparticles (from Alfa Aesar corp.), polyimide liquid precursor (PI 2611 from HD Microsystems corp.), graphite particles (SLP30 from Timcal corp.), milled carbon fibers (from Fibre Glast Developments corp.), carbon nanofibers (CNF from Pyrograf corp.), carbon nanotubes (from CNANO Technology Limited), conductive carbon particles (Super P from Timcal corp.), conductive graphite particles (KS6 from Timca corp.) were mixed in the weight ratio of 20:200:30:8:4:2:1:15 using a vortexer for 5 minutes. The mixture was then cast onto aluminum foil. The samples were then allowed to dry in a 90° C. oven to drive away solvents, e.g., NMP. This was followed by a curing step at 200° C. in a hot press, under negligible pressure, for at least 12 hours. The aluminum foil backing was then removed by etching in a 12.5% HCl solution. The remaining film was then rinsed in DI water, dried and then pyrolyzed for around an hour at 1175° C. under argon. The process resulted in a composition similar to the original mixture but with a PI 2611 derived carbon portion that was 7.5% the original weight of the polyimide precursor.

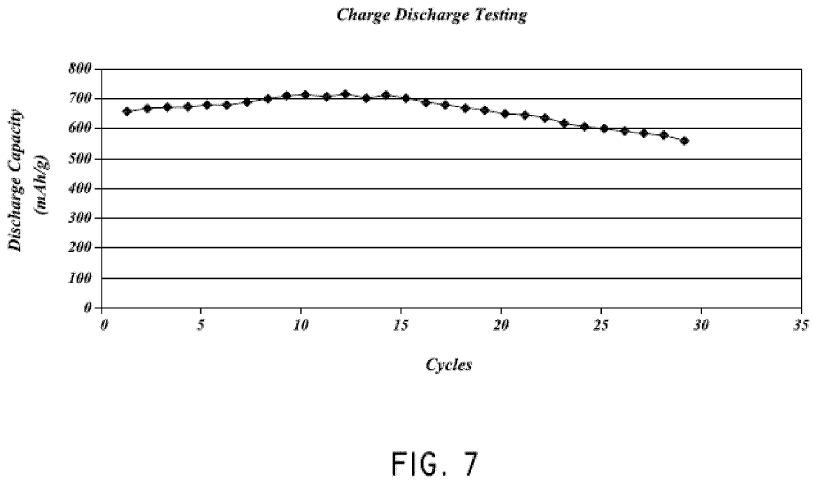

The resulting electrodes were then tested in a pouch cell configuration against a lithium NMC oxide cathode. A typical cycling graph is shown in FIG. 7.

### Example 5

In Example 5, polyimide liquid precursor (PI 2611 from HD Microsystems corp.), and silicon microparticles (from Alfa Aesar corp.) were mixed together using a Turbula mixer for a duration of 1 hours in the weight ratio of 4:1. The mixture was then cast onto aluminum foil covered with a carbon veil (from Fibre Glast Developments Corporation) and allowed to dry in a 90° C. oven to drive away solvents, e.g., NMP. This was followed by a curing step at 200° C. in a hot press, under negligible pressure, for at least 12 hours. The aluminum foil backing was then removed by etching in a 12.5% HCl solution. The remaining film was then rinsed in DI water, dried and then pyrolyzed around an hour at 1175° C. under argon flow. The process resulted in a composition of approximately 23% of PI 2611 derived carbon, 76% of silicon by weight, and the weight of the veil being negligible.

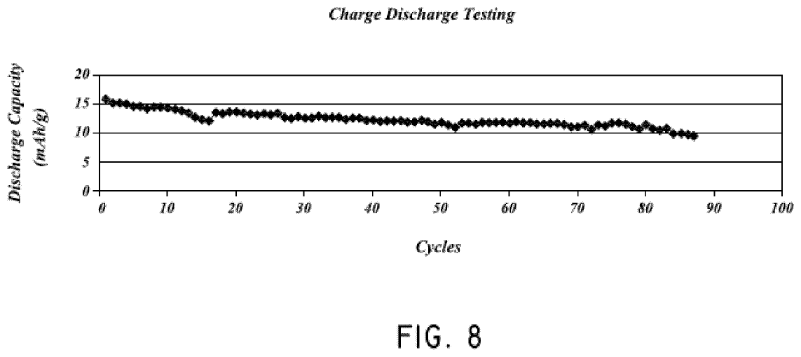

The resulting electrodes were then tested in a pouch cell configuration against a lithium nickel manganese cobalt oxide (NMC) cathode. A typical cycling graph is shown in FIG. 8.

### Example 6

In Example 6, polyimide liquid precursor (PI 2611 from HD Microsystems corp.), graphite particles (SLP30 from Timcal corp.), and silicon microparticles (from Alfa Aesar corp.) were mixed together for 5 minutes using a Spex 8000D machine in the weight ratio of 200:10:70. The mixture was then cast onto aluminum foil and allowed to dry in a 90° C. oven, to drive away solvents (e.g., NMP). The dried mixture was cured at 200° C. in a hot press, under negligible pressure, for at least 12 hours. The aluminum foil backing was then removed by etching in a 12.5% HCl solution. The remaining film was then rinsed in DI water, dried and then pyrolyzed at 1175° C. for about one hour under argon flow. The process resulted in a composition of 15.8% of PI 2611 derived carbon, 10.5% of graphite particles, 73.7% of silicon by weight.

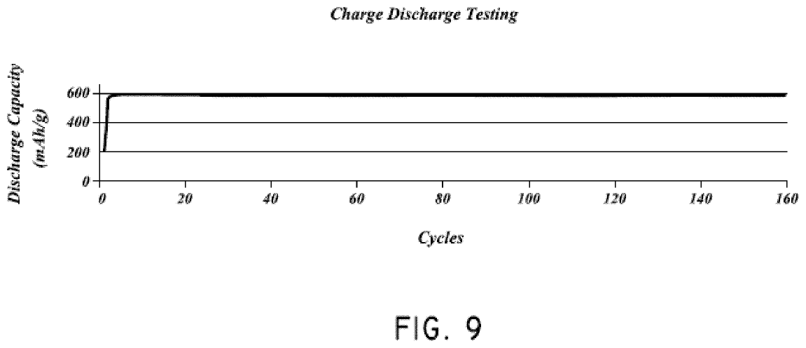

The resulting electrodes were then tested in a pouch cell configuration against a lithium NMC oxide cathode. The anodes where charged to 600 mAh/g each cycle and the discharge capacity per cycle was recorded. A typical cycling graph is shown in FIG. 9.

### Example 7

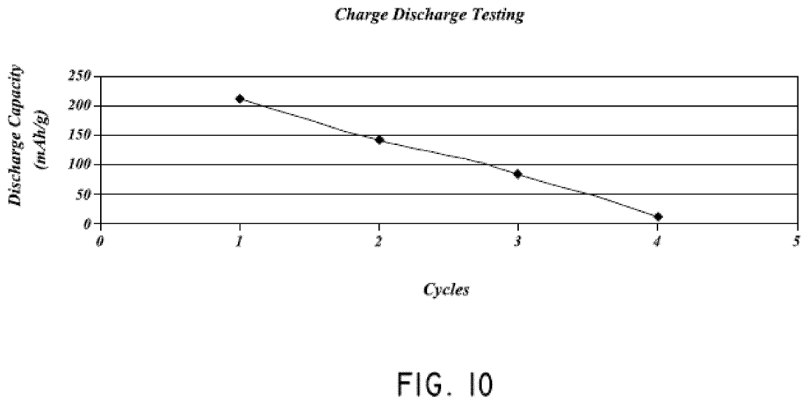

In Example 7, PVDF and silicon particles (from EVNANO Advanced Chemical Materials Co), conductive carbon particles (Super P from Timcal corp.), conductive graphite particles (KS6 from Timcal corp.), graphite particles (SLP30 from Timcal corp.) and NMP were mixed in the weight ratio of 5:20:1:4:70:95. The mixture was then cast on a copper substrate and then placed in a 90° C. oven to drive away solvents, e.g., NMP. The resulting electrodes were then tested in a pouch cell configuration against a lithium NMC Oxide cathode. A typical cycling graph is shown in FIG. 10.

### Example 8

Multiple experiments were conducted in order to find the effects of varying the percentage of polyimide derive carbon (e.g. 2611c) while decreasing the percentage of graphite particles (SLP30 from Timcal corp.) and keeping the percentage of silicon microparticles (from Alfa Aesar corp.) at 20 wt. %.

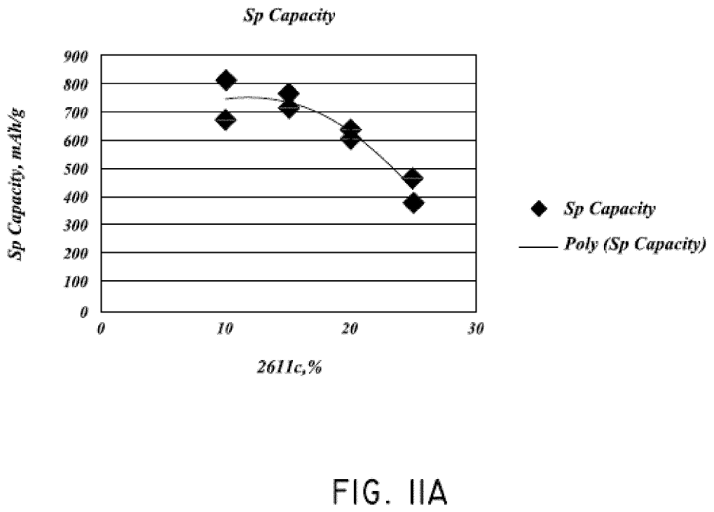

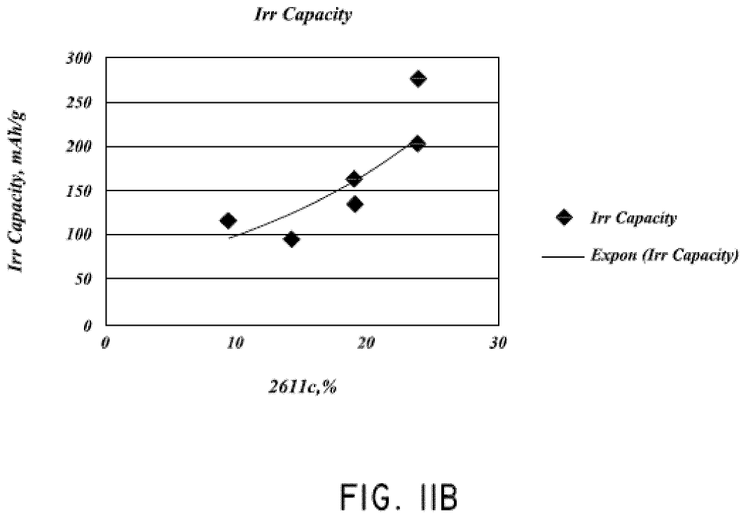

As shown in FIGS. 11A and 11B, the results show that more graphite and less 2611c was beneficial to cell performance by increasing the specific capacity while decreasing the irreversible capacity. Minimizing 2611c adversely affected the strength of the resultant anode so a value close to 20 wt. % can be preferable as a compromise in one embodiment.

### Example 9

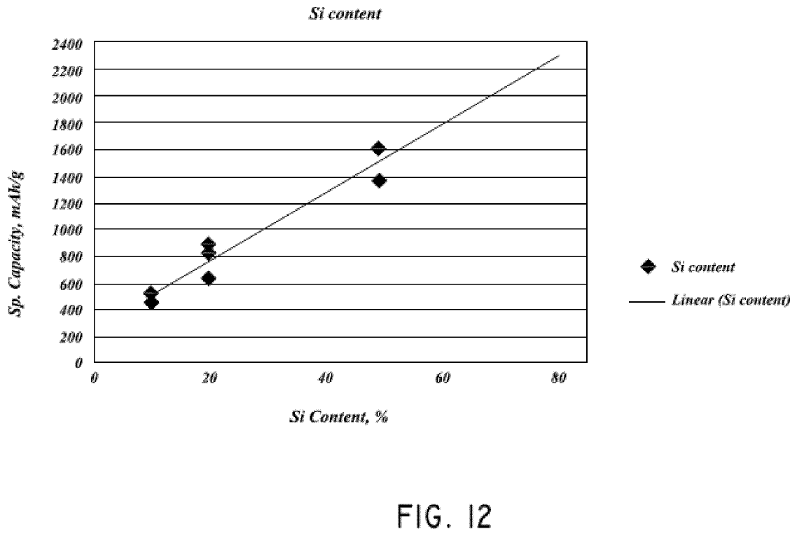

Similar to example 8, if 2611c is kept at 20 wt. % and Si percentage is increased at the expense of graphite particles, the first cycle discharge capacity of the resulting electrode is increased. FIG. 12 shows that a higher silicon content can make a better performing anode.

### Example 10

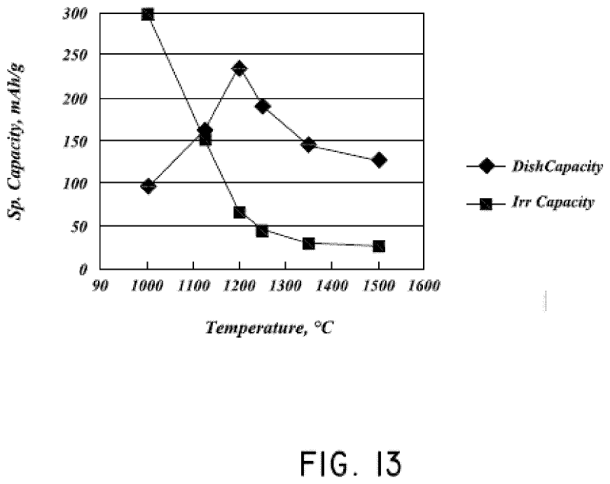

When 1 mil thick sheets of polyimide are pyrolized and tested in accordance with the procedure in Example 1. The reversible capacity and irreversible capacity were plotted as a function of the pyrolysis temperature. FIG. 13 indicates that, in one embodiment, it is preferable to pyrolyze polyimide sheets (Upilex by UBE corp.) at around 1175° C.

### Additional Examples

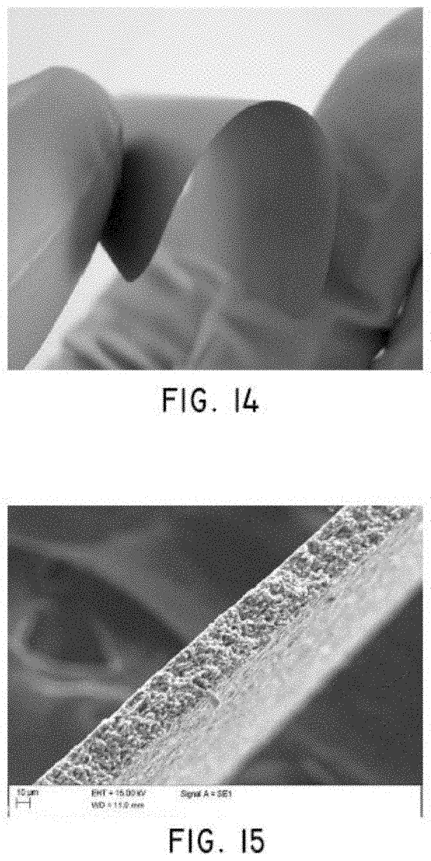

FIG. 14 is a photograph of a 4.3 cm×4.3 cm composite anode film without a metal foil support layer. The composite anode film has a thickness of about 30 microns and has a composition of about 15.8% of PI 2611 derived carbon, about 10.5% of graphite particles, and about 73.7% of silicon by weight.

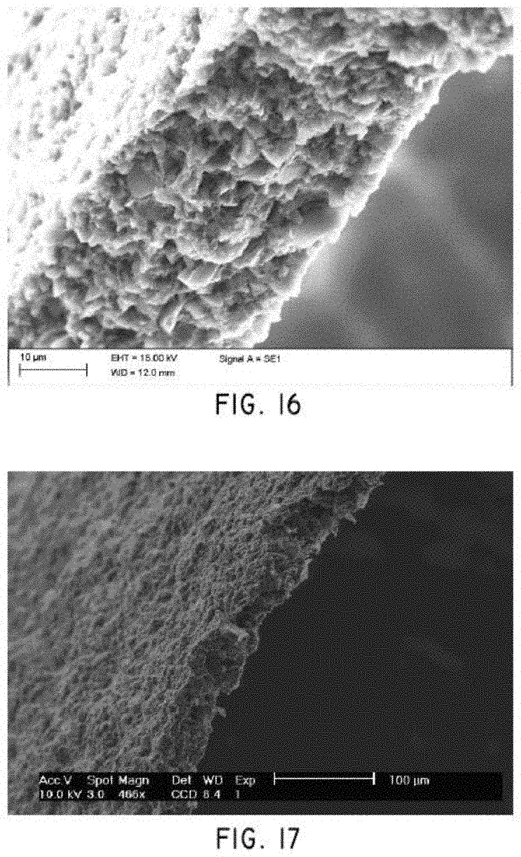

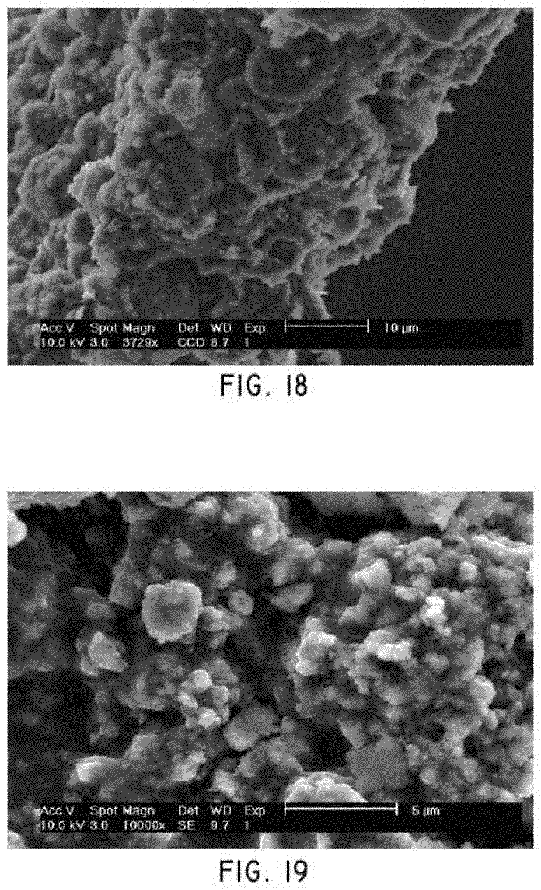

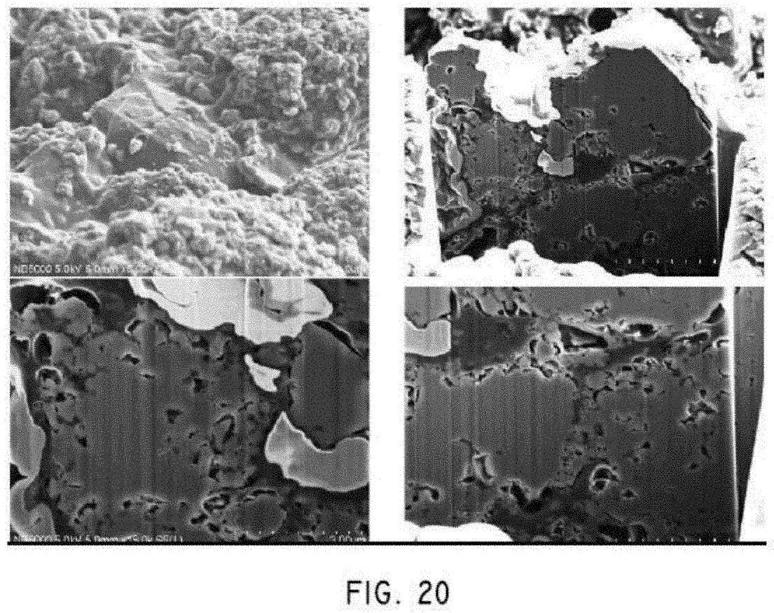

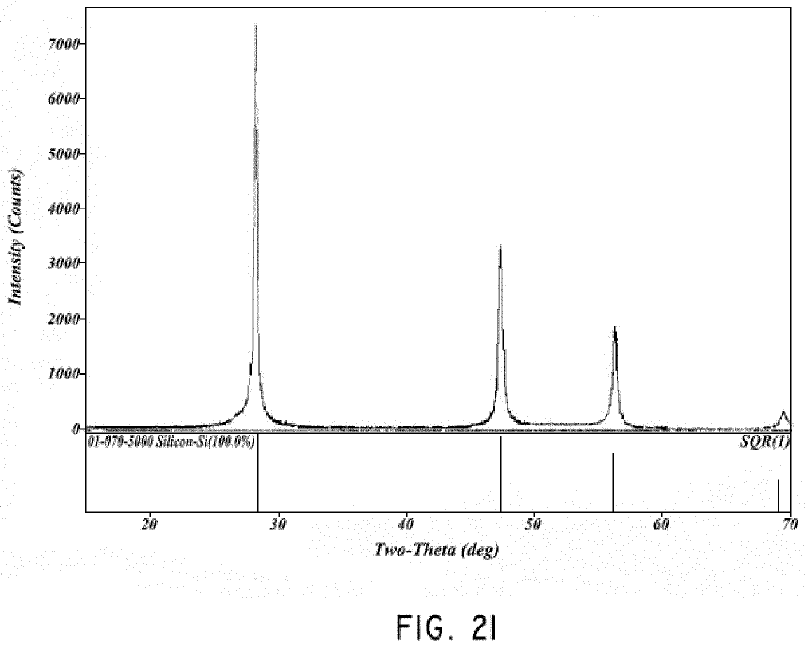

FIGS. 15-20 are scanning electron microscope (SEM) micrographs of a composite anode film. The compositions of the composite anode film were about 15.8% of PI 2611 derived carbon, about 10.5% of graphite particles, and about 73.7% of silicon by weight. FIGS. 15 and 16 show before being cycled (the out-of-focus portion is a bottom portion of the anode and the portion that is in focus is a cleaved edge of the composite film). FIGS. 17, 18, and 19 are SEM micrographs of a composite anode film after being cycled 10 cycles, 10 cycles, and 300 cycles, respectively. The SEM micrographs show that there is not any significant pulverization of the silicon and that the anodes do not have an excessive layer of solid electrolyte interface/interphase (SEI) built on top of them after cycling. FIG. 20 are SEM micrographs of cross-sections of composite anode films.

Described below are measured properties of example silicon particles. These examples are discussed for illustrative purposes and should not be construed to limit the scope of the disclosed embodiments.

FIG. 21 is an x-ray powder diffraction (XRD) graph of the sample silicon particles. The XRD graph suggests that the sample silicon particles were substantially crystalline or polycrystalline in nature.

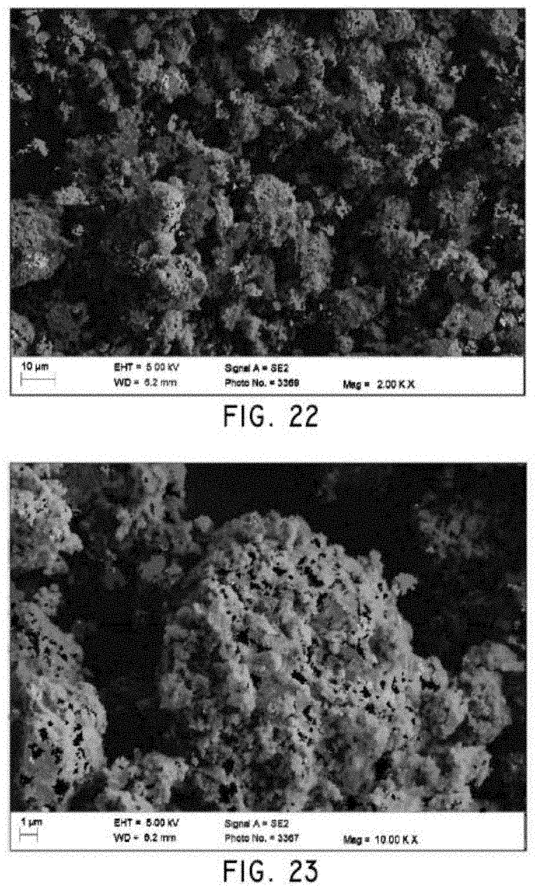

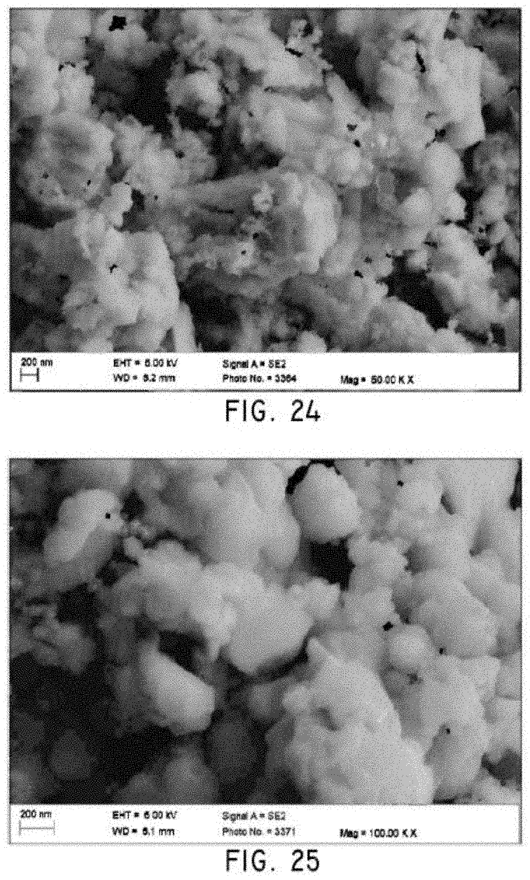

FIGS. 22-25 are scanning electron microscope (SEM) micrographs of the sample silicon particles. Although the SEM micrographs appear to show that the silicon particles may have an average particle size greater than the measured average particle size of about 300 nm, without being bound by theory, the particles are believed to have conglomerated together to appear to be larger particles.

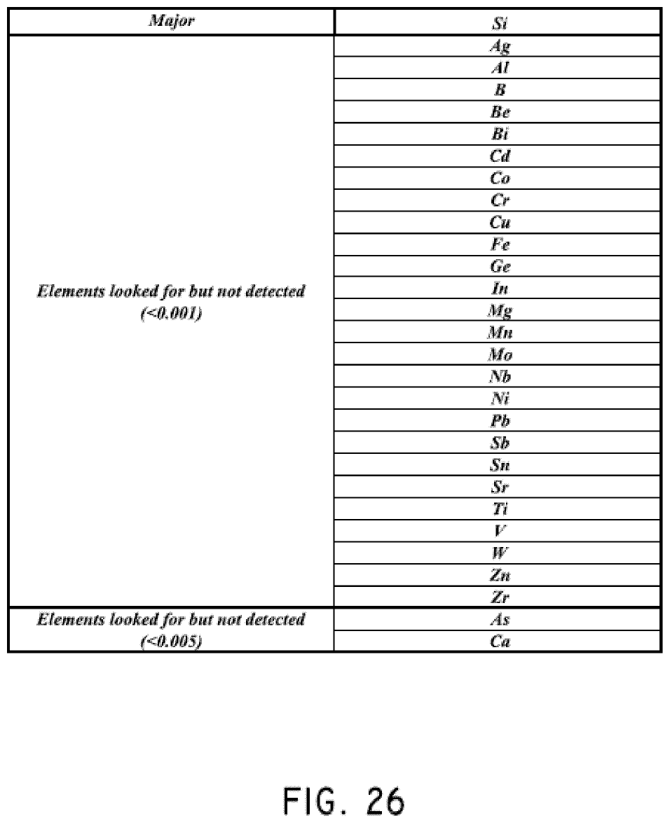

FIG. 26 is a chemical analysis of the sample silicon particles. The chemical analysis suggests that the silicon particles were substantially pure silicon.

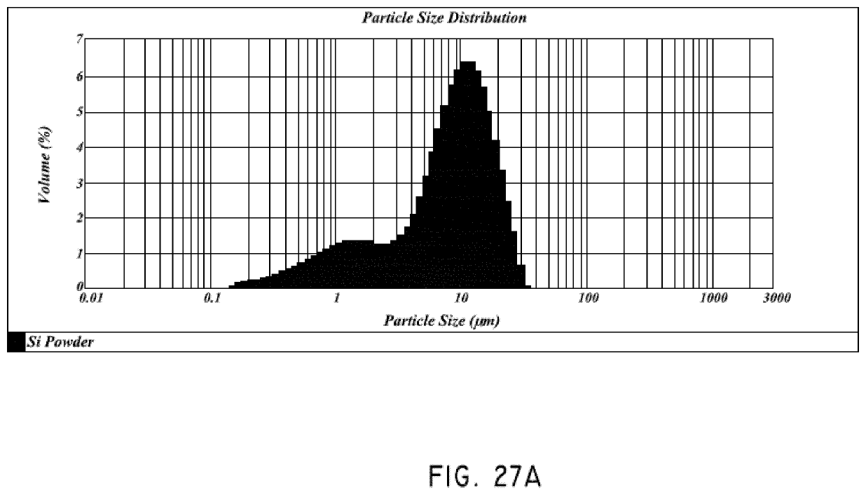

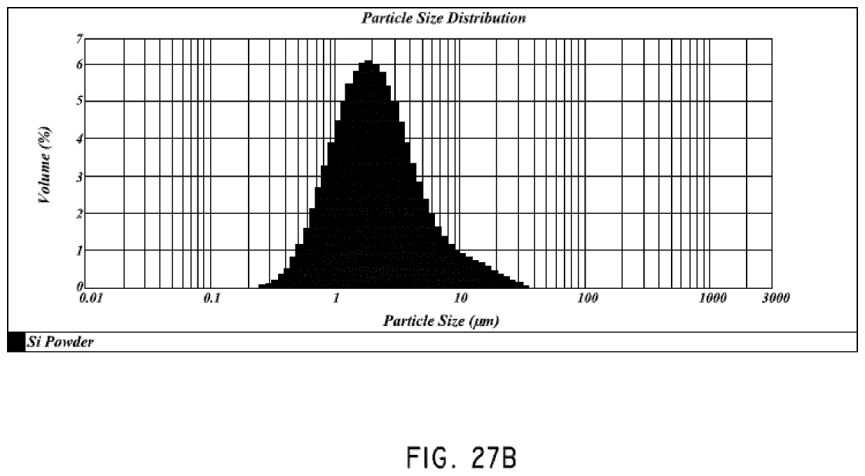

FIGS. 27A and 27B are example particle size histograms of two micron-sized silicon particles with nanometer-sized features. The particles were prepared from a FBR process. Example silicon particles can have a particle size distribution. For example, at least 90% of the particles may have a particle size, for example, a diameter or a largest dimension, between about 5 μm and about 20 μm (e.g., between about 6 μm and about 19 μm). At least about 50% of the particles may have a particle size between about 1 μm and about 10 μm (e.g., about 2 μm and about 9 μm). Furthermore, at least about 10% of the particles may have a particle size between about 0.5 μm and about 2 μm (e.g., about 0.9 μm and about 1.1 μm).

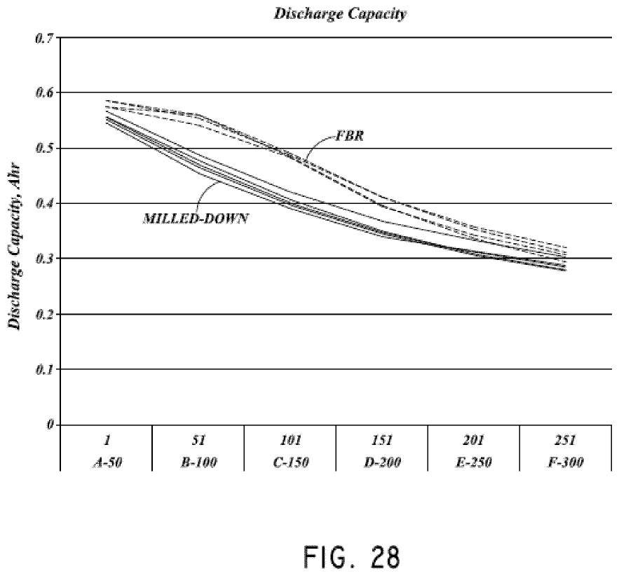

FIG. 28 is a plot of discharge capacity during cell cycling comparing two types of example silicon particles. The performance of four samples of silicon particles (micron-sized particles with nanometer-sized features) prepared by the FBR process are compared with five samples of silicon particles prepared by milling-down larger silicon particles. Thus, certain embodiments of silicon particles with the combined micron/nanometer geometry (e.g., prepared by the FBR process) can have enhanced performance over various other embodiments of silicon particles (e.g., micron-sized silicon particles prepared by milling down from larger particles). The type of silicon particles to use can be tailored for the intended or desired application and specifications.

Examples of Silicon-Dominant Electrodes

Resin Preparation: High molecular weight (e.g., about 150,000 g/mol) PAN powder was dispersed in dipolar aprotic solvent NMP overnight at 75° C. to obtain 12% solid content resin in this case. Higher molecular weights (e.g., greater than 150,000 g/mol, such as up to about 700,000 g/mol or up to about 750,000 g/mol) can also be used. Lower molecular weights, such as about 50,000 g/mol to about 150,000 g/mol, can be used as well. Solvents such as DMF, DMSO, and DMAc can also be used. In addition, higher temperatures under gelation temperatures and/or under flash points of these solvents can also be used

Slurry and Anode Preparation: Silicon nano/microparticles were dispersed in the PAN resin under high shear conditions (e.g., using a centrifugal planetary mixer at 2000 rpm for 10 minutes) to get a uniform slurry with >20% Si by weight. De-agglomeration of Si particles can also be achieved using a ball mill step of Si particles in a solvent and can be dispersed in the resin to produce a slurry. The slurry was cast on a polyethylene teraphthalate substrate and dried to remove most of the residual solvent. Sacrificial substrates, such as substrates with zero, close to zero, or low char yield (e.g., polypropylene), can also be used. The thin coated anode (dry loading of 3.63 mg/cm²) was peeled from polyethylene teraphthalate substrate, blanked into smaller pieces, and stacked in stacks of 10. The stacked green anodes were oxidized by heating in an air convection oven at temperatures 200° C. for a 15 hours. The stacking of anodes, either in self standing substrate-less form or on low char yield substrate, can lead to limited air/oxygen mass transport to the green anodes. The oxidized/stabilized composite anodes were pyrolysed in a furnace under Argon inert atmospheres at temperatures over 1175° C. to get silicon carbon composite anodes.

The char yield and final Si weight % in the anode can be controlled by controlling the oxidation and pyrolysis process. Oxidation/stabilization conditions such as temperature, ramp rates, and atmosphere and the subsequent heat treatment condition under inert /reducing atmosphere can be controlled to vary the PAN char yield in the final substrateless anode. Some of the different conditions on unstacked PAN-Silicon green anodes are shown in Table 1. In conditions 8 and 9, the un-oxidized PAN anodes reflowed (e.g., didn't preserve film structure) and were unable to be processed further. The char yield can be further reduced by reducing the oxidation temperature between 100° C. and 200° C. (for example) and increasing the duration to 24-48 hours, oxidizing enough to avoid reflow, keeping the final pyrolysis heat treatment conditions the same.

TABLE 1

| | Stabilization/Oxidation | | | Heat treatment under Argon | | |
|---|---|---|---|---|---|---|
| Condition | temp (° C.) | time | atmosphere | temp | | time |
| 1 | 300 | 30° C./min, 30 min | Air, ceramic furnace | 700° | C. | 5° C./min, 1 hr |
| 2 | 300 | 30° C./min, 30 min | Air, ceramic furnace | 1175° | C. | 5° C./min, 1 hr |
| 3 | 300 | 4° C./min, 30 min | Air, ceramic furnace | 700° | C. | 5° C./min, 1 hr |
| 4 | 300 | 4° C./min, 30 min | Air, ceramic furnace | 1175° | C. | 5° C./min, 1 hr |
| 5 | 300 | 30° C./min, 15 hours | Air, ceramic furnace | 700° | C. | 5° C./min, 1 hr |
| 6 | 300 | 30° C./min, 15 hours | Air, ceramic furnace | 1175° | C. | 5° C./min, 1 hr |
| 7 | 230, 245, | 30° C./min, 15 min | Air, ceramic furnace | 700° | C. | 10° C./min, 1 hr |
| | 253, 265 | at each temp | | | | |
| 8 | — | NA | NA | 700° | C. | 5° C./min, 1 hr |
| 9 | — | NA | NA | 1175° | C. | 5° C./min, 1 hr |
| 10 | 200 | 30° C./min, 30 min | Air, ceramic furnace | 700° | C. | 5° C./min, 1 hr |
| 11 | 200 | 30° C./min, 30 min | Air, ceramic furnace | 1175° | C. | 5° C./min, 1 hr |
| 12 | 150 | 30° C./min, 30 min | Air, ceramic furnace | 700° | C. | 5° C./min, 1 hr |
| 13 | 150 | 30° C./min, 30 min | Air, ceramic furnace | 1175° | C. | 5° C./min, 1 hr |

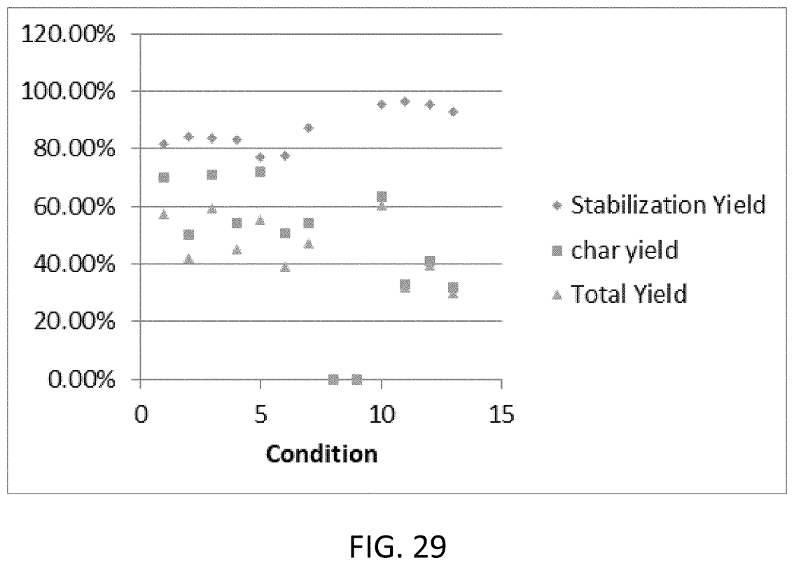

FIG. 29 shows the stabilization/oxidation and char yields of PAN under different heat treatment conditions. The stabilization/oxidation yield was calculated as the weight after stabilization/oxidation divided by the original weight before stabilization/oxidation. The char yield was calculated as the weight after pyrolysis divided by the original weight before pyrolysis. The actual char yields for stacked green anodes were much lower than in FIG. 29 (e.g., the actual char yield obtained for 84% Silicon anodes was 39% and that for 94% Si anodes was 29%) since the stacking reduces the bulk oxygen/air flow between the anodes causing them to be partially oxidized. The degree of oxidation of green anodes in a stacked form may also depend on the dimensions of the green anodes, stack size, degree of convection in the oven and compressive pressure from the weight on top of the stack in some instances. In the anodes cycled here, the anode dimensions were 12 cm×9 cm×30 um, and the pressure on the stack was 0.6psi. The oven used was gravity oven (e.g., no forced air) at 200° C. These anodes were built into 5 layers cells with nickel based cathode and standard carbonate based electrolytes and tested under cycling conditions. The test vehicle and conditions are provided below.

### Test Vehicle

Cathode: NMC 622 23 mg/cm2 loading
Electrolyte: carbonate based electrolyte
5 layer cells, 710 mAh estimated capacity

### Test Conditions:

| | Details |
|---|---|
| Cycle No. | Data Recording Every 30 Seconds |
| 1 | Charge at 0.5 C to 4.2 V until 0.05 C, |
| | rest 5 minutes, 1 ms IR, 100 ms IR, |
| | discharge at 0.2 C to 2.75 V, |
| | rest 5 minutes, 1 ms IR, 100 ms IR |
| 2 | Charge at 2 C to 4.2 V until 0.05 C, |
| | rest 5 minutes, 1 ms IR, 100 ms IR, |
| | discharge at 1 C to 2.75 V, |
| | rest 5 minutes, 1 ms IR, 100 ms IR |
| 3-50 | Same as Cycle 2 |
| 51 | Same as Cycle 1 |
| 52-100 | Same as Cycle 2 |
| 101 | Same as Cycle 1 |
| . . . | . . . |

Silicon-carbon composite anodes produced by coating silicon-graphite (or similar carbon sources such as graphene, carbon black etc.) slurry with some polymeric binder, dispersed in a solvent, on current collector substrates followed by drying and pressing have drawbacks of poor reversible capacity and poor capacity retention, losing more than 50% capacity in first 30 cycles. Certain embodiments of silicon dominant anodes described herein demonstrate much better capacity retention when cycled at a broad voltage window.

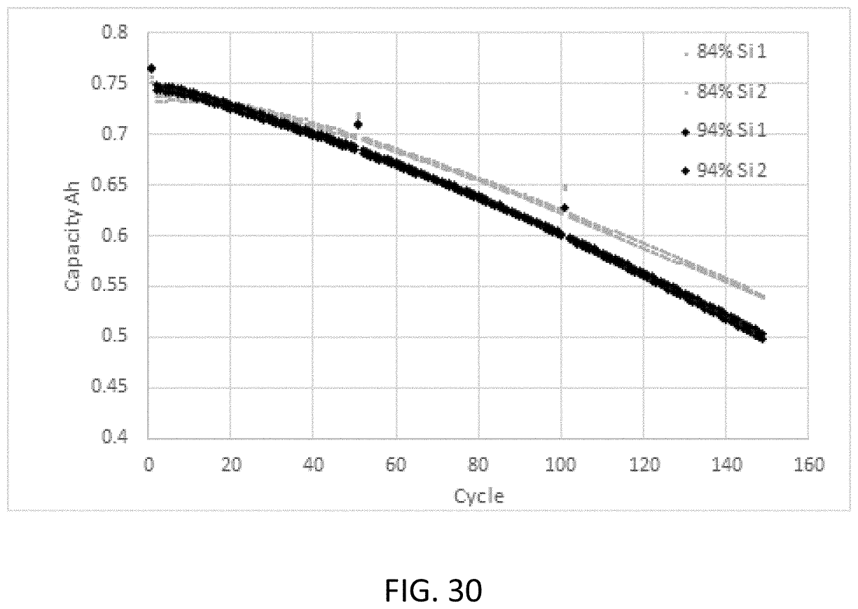

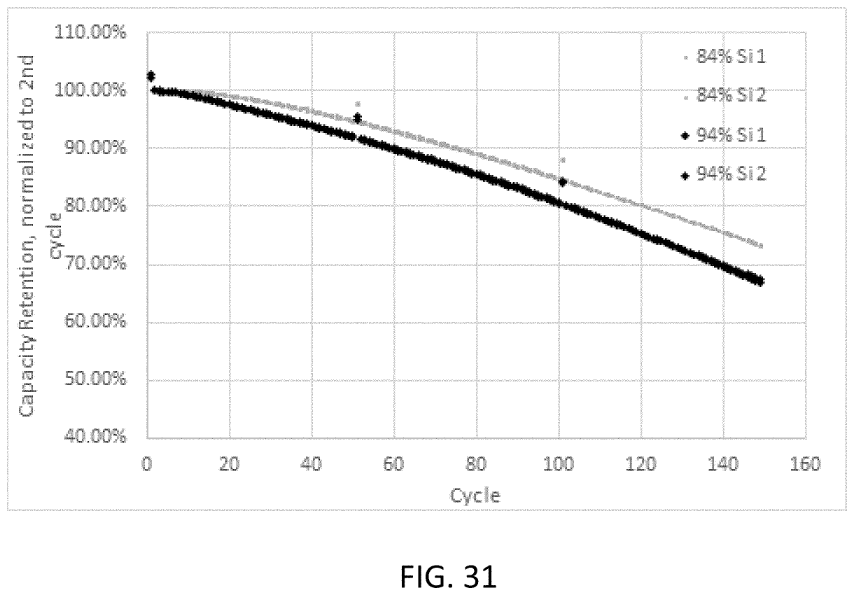

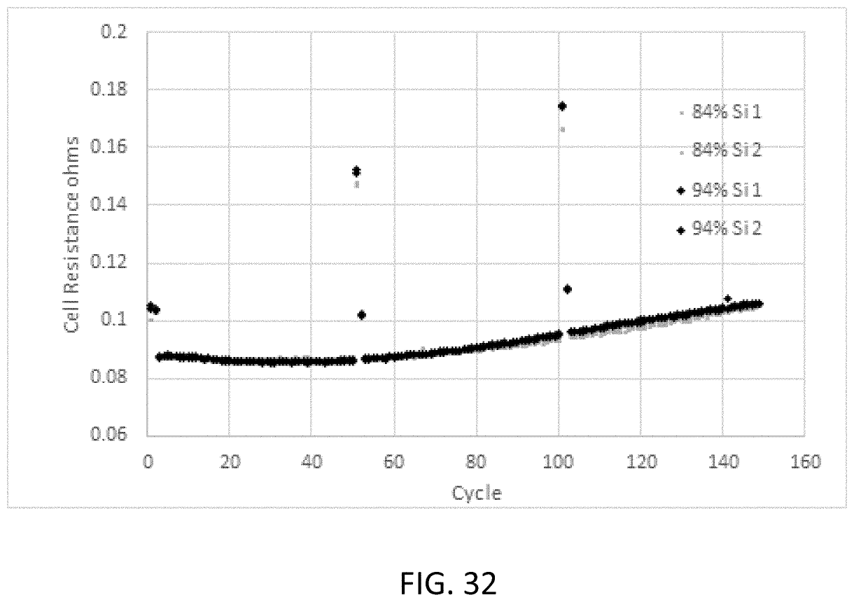

FIG. 30 shows a graph of capacity versus the cycle number of cells with the example silicon-dominant anodes. FIG. 31 shows a graph of the capacity retention versus the cycle number of cells with the example silicon-dominant anodes. The cell resistance does not increase much during cycling which is indicative of a mechanically stable anode. Poor mechanical stability/structural integrity of silicon dominant anodes due to extreme volume changes of anodes can be a major concern which can be detrimental to cycle life of lithium ion batteries containing such anodes. Without being bound by theory, the cells with 94% Si anodes may start with slightly higher capacity due to more active content, e.g., Si. In FIGS. 30 and 31, the cells with 84% Si anodes seem to have higher capacity and retention with cycling. Without being bound by theory, this may be because the 84% Si anodes included high surface area (4%) graphite material as an additive, which may provide better electrical contact during cycling. In some implementations, cells with 94% Si material may demonstrate better capacity and retention with such an additive. FIG. 32 shows a graph of cell resistance versus cycle number for cells with example silicon-dominant anodes. At 150 cycles, the cell resistance for the cells with the 94% Si anodes is slightly higher than the cells with the 84% Si anodes. Without being bound by theory, this may be because of the lack of the electrically conductive graphite additive after cycling in the cells with the 84% Si anodes. After 150 cycles, the cells showed a much lower increase in cell resistance.

Various embodiments have been described above. Although the invention has been described with reference to these specific embodiments, the descriptions are intended to be illustrative and are not intended to be limiting. Various modifications and applications may occur to those skilled in the art without departing from the true spirit and scope of the invention as defined in the appended claims.

1. A method of forming a composite material film, the method comprising:
providing a mixture comprising a carbon precursor and silicon particles; and
pyrolysing the carbon precursor to convert the precursor into one or more types of carbon phases to form the composite material film such that the precursor has a char yield of greater than about 0% to about 60% and the composite material film comprises the silicon particles at about 90% to about 99% by weight.

2. The method of claim 1, wherein the composite material film comprises the silicon particles at about 95% to about 99% by weight.

3. The method of claim 1, wherein the carbon precursor comprises polyacrylonitrile (PAN).

4. The method of claim 1, wherein the carbon precursor comprises cellulose, glucose, sucrose, lignin, dextran, or a combination thereof.

5. The method of claim 1, wherein the carbon precursor comprises polyimide, phenol formaldehyde resin, or a combination thereof.

6. The method of claim 1, wherein the carbon precursor comprises polyamic acid.

7. The method of claim 6, wherein the carbon precursor comprises dianhydride and/or diamine.

8. The method of claim 7, wherein the carbon precursor comprises pyromellitic dianhydride oxidianiline (PMDA-ODA), biphenyl tetracarboxylic acid dianhydride-p-phenylene diamine (BPDA-PDA), pyromellitic dianhydride-p-phenylene diamine (PMDA-PDA), or a combination thereof.

9. The method of claim 1, wherein the mixture further comprises a solvent comprising N-Methylpyrrolidone (NMP).

10. The method of claim 1, wherein the mixture further comprises an aprotic solvent.

11. The method of claim 10, wherein the aprotic solvent comprises of any one or mixture of dimethylformamide (DMF), dimethoxymethamphetamine (DMMA), dimethylacetamide (DMAc), dimethyl sulfoxide (DMSO), sulfolane, ethylene carbonate, or a combination thereof.

12. The method of claim 1, wherein the mixture further comprises an inorganic salt.

13. The method of claim 12, wherein the inorganic salt comprises lithium bromide, sodium thiocyanate, zinc chloride, or a combination thereof.

14. The method of claim 1, wherein the mixture further comprises sulfuric acid, nitric acid, or a combination thereof.

15. The method of claim 1, further comprising coating the mixture on a substrate to form a green film.

16. The method of claim 15, further comprising removing the green film from the substrate prior to pyrolysing the carbon precursor.

17. The method of claim 16, wherein the substrate comprises polyethylene terephthalate (PET), cyclic olefin copolymer (COC), or a combination thereof.

18. The method of claim 15, wherein pyrolysing comprises pyrolysing the green film on the substrate.

19. The method of claim 18, wherein the substrate comprises a polymer having about 0% to about 5% char yield.

20. The method of claim 19, wherein the substrate comprises acetal, polypropylene, polyethylene, polystyrene, or a combination thereof.

21. The method of claim 1, further comprising oxidizing the mixture prior to pyrolysing.

22. The method of claim 1, wherein pyrolysing comprises heating the mixture at a temperature in a range of about 350° C. to about 1350° C.

23. The method of claim 1, wherein pyrolysing forms the composite material film as a self-supported structure.

24.-43. (canceled)
